(19) United States
(12) Patent Application Publication
(10) Pub. No.: US 2016/0300033 A1
(43) Pub. Date: Oct. 13, 2016

(54) CARE COORDINATION SYSTEMS AND METHODOLOGIES

(71) Applicant: MASTODON, LLC, Davidson, NC (US)

(72) Inventors: David O. Duke, Arroyo Grande, CA (US); Janet Duke, Arroyo Grande, CA (US); Joe Jauregui, Davidson, NC (US); Ken Nussear, Boulder City, NV (US)

(21) Appl. No.: 15/095,526

(22) Filed: Apr. 11, 2016

Related U.S. Application Data
(63) Continuation-in-part of application No. PCT/US16/26852, filed on Apr. 10, 2016.
(60) Provisional application No. 62/146,119, filed on Apr. 10, 2015.
(60) Provisional application No. 62/146,119, filed on Apr. 10, 2015.

(51) Int. Cl. G06F 19/00; G06F 3/0482

(52) U.S. Cl. CPC G06F 19/3425; G06F 3/0482; G06F 19/3431

(57) ABSTRACT

A system provides an interface which includes a plurality of rows associated with patients, and a plurality of data columns for different departments that provide a holistic overview of action items for the different departments. Cells in the data columns can be manipulated, e.g. by selection of an option in a dropdown menu for the cell, to request an action of a corresponding department, or to indicate completion of a task by the corresponding department. Input into a cell can also automatically trigger changing of data or color coding in another cell for the patient. Color coding is utilized to allow viewers to quickly assimilate information from a displayed interface of the system. A number of calculations are performed based on input and/or imported data. For example, a value or color coding may be altered based on a calculated risk of readmission score.

### CROSS-REFERENCE TO RELATED APPLICATIONS

The present application is a U.S. continuation-in-part patent application of, and claims priority under 35 U.S.C. §120 to, international patent application no. PCT/US16/26852, filed Apr. 10, 2016, which patent application and any patent application publications thereof are incorporated by reference herein, and the present application is a U.S. nonprovisional patent application of, and claims priority under 35 U.S.C. §119(e) to, U.S. provisional patent application Ser. No. 62/146,119, filed Apr. 10, 2015, which provisional patent application is hereby incorporated herein by reference.

The present application hereby incorporates herein by reference the entire disclosure of Appendices A-E attached hereto.

### COPYRIGHT STATEMENT

All of the material in this patent document, including the computer program listing, is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### COMPUTER PROGRAM LISTING

Submitted concurrently herewith via the electronic filing system of the U.S. Patent & Trademark Office, and incorporated herein by reference, is a computer program listing for computer file(s), including a compressed archive file which includes a spreadsheet in accordance with one or more preferred embodiments of the present invention, and a video describing aspects and features in accordance with the present invention. A table setting forth the name and size of each file included in the computer program listing is provided below.

| File Name | Creation Date | Size in Bytes |
|---|---|---|
| ascify.txt | Apr. 10, 2015 17:45 | 37473 |
| readme.txt | Apr. 10, 2015 17:45 | 2669 |
| zip1.txt | Apr. 10, 2015 17:44 | 22478505 |
| zip10.txt | Apr. 10, 2015 17:44 | 22475418 |
| zip11.txt | Apr. 10, 2015 17:44 | 22475075 |
| zip12.txt | Apr. 10, 2015 17:44 | 22474732 |
| zip13.txt | Apr. 10, 2015 17:44 | 1573592 |
| zip2.txt | Apr. 10, 2015 17:44 | 22478162 |
| zip3.txt | Apr. 10, 2015 17:44 | 22477819 |
| zip4.txt | Apr. 10, 2015 17:44 | 22477476 |
| zip5.txt | Apr. 10, 2015 17:44 | 22477133 |
| zip6.txt | Apr. 10, 2015 17:44 | 22476790 |
| zip7.txt | Apr. 10, 2015 17:44 | 22476447 |
| zip8.txt | Apr. 10, 2015 17:44 | 22476104 |
| zip9.txt | Apr. 10, 2015 17:44 | 22475761 |

The “README.TXT” file contains instructions for utilizing “ASCIFY.TXT” to combine the “zipx.txt” files into a compressed .zip file. The compressed file includes a Microsoft Excel Spreadsheet and an Apple Quicktime Movie video file. The target system requirements for viewing these files comprises a personal computer running a Microsoft Windows™ operating system, such as Windows XP, Windows 7, Windows 8, Windows 10, or a personal computer running an Apple operating system.

### BACKGROUND OF THE INVENTION

The present invention generally relates to systems and methodologies for facilitating coordination of communications and tasks between multiple individuals or teams, such as in a medical context for coordinating follow up with patients following discharge from an acute care setting.

Historically, in a medical context, teams of care providers work in isolation, disconnected and disjointed. Currently, hospital readmissions are relatively high, which leads to increased costs. To attempt to address this, hospital administrators sometimes have nurses make follow up calls to check on the status of patients. One problem, however, is that staff tasked with follow up communications do not necessarily know who else may have already followed up. Further, there is no way to advise another party such as a pharmacy, hospice, pastor, spiritual advisor, etc. that a call or other communication is needed. Patients can become frustrated because calls are repeated.

Needs exist for improvement in coordination communications, such as, for example, coordinating communications representing follow up with patients following discharge from an acute care setting. These needs and other needs are addressed by one or more aspects of the present invention.

### SUMMARY OF THE INVENTION

The present invention includes many aspects and features. Moreover, while many aspects and features relate to, and are described in, the context of follow up with patients following discharge from an acute care setting, the present invention is not limited to use only in this context, as will become apparent from the following summaries and detailed descriptions of aspects, features, and one or more embodiments of the present invention.

Accordingly, one aspect of the present invention relates to a system that provides an interface which includes a plurality of rows associated with patients, and a plurality of data columns for different departments that provide a holistic overview of action items for the different departments. Cells in the data columns can be manipulated, e.g. by selection of an option in a dropdown menu for the cell, to request an action of a corresponding department, or to indicate completion of a task by the corresponding department. Input into a cell can also automatically trigger changing of data or color coding in another cell for the patient. Color coding is utilized to allow viewers to quickly assimilate information from a displayed interface of the system. The display of rows for different departments results in display of a parallel and interlinked action item list which is visible to multiple, teams, departments, and managers, and is actionable by multiple parties rather than just one. A department can request an action by another department and will see in the system when that action has been completed. The system is configured to perform a number of calculations based on input and/or imported data. For example, in some implementations, the system is configured to calculate a risk of readmission score for each patient, and present this score in a column. Alternatively, the system may import a risk of readmission score calculated elsewhere. In either event, in some implementations the system may alter a value and/or color coding in one or more cells for that patient to indicate that, based on the risk of readmission score, a follow up action is needed by a department.

Another aspect relates to a method for facilitating coordination between teams concerned with care of patients, the method comprising: importing, into a system, data for a plurality of patients from one or more medical software programs; displaying, to a first user via a display of a first electronic device, an interface comprising a plurality of rows and a plurality of columns, the interface comprising data imported into the system, and the rows including a plurality of rows each corresponding to a particular patient, wherein the columns include a plurality of columns each corresponding to a particular one of the teams concerned with care of patients, and for each respective cell lying in a respective row associated with a respective patient and in a respective column associated with a respective team, the interface is configured to allow for both display in the respective cell of a status message indicating a status of communication by the respective team with the respective patient, and user interaction with the respective cell which effects display of a menu of available actions that can be requested of the respective team with respect to the respective patient, and effects selection of one of the available actions, wherein user selection of an available action effects updating in the interface of a displayed status message for the respective cell, and the columns include a column containing a calculated risk score, rows associated with a patient are sorted based at least in part on respective calculated risk scores for each patient to prioritize communications with patients who are at greater risk; receiving, from the first user via one or more input devices associated with the first electronic device, input corresponding to interaction with a first respective cell associated with a first respective patient and a first respective team, such input representing a request to effect communication with the first respective patient by the first respective team; updating, based on the received user input representing a request to effect communication with the first respective patient by the first respective team, the first respective cell of the interface to indicate the request; displaying, to a second user via a display of a second electronic device, the updated interface including the indication of the request in the first respective cell; receiving, from the second user via one or more input devices associated with the second electronic device, input corresponding to interaction with the first respective cell, such input representing an indication of a status of communications with the first respective patient by the first respective team; updating, based on the received user input representing an indication of a status of communications with the first respective patient by the first respective team, the first respective cell to reflect such status; displaying, to the first user via the display of the first electronic device, the updated interface including the indicated status of communications in the first respective cell.

In a feature of this aspect, the system comprises a spreadsheet, and wherein importing into the system comprises importing into a spreadsheet.

In a feature of this aspect, the system comprises a web application configured to generate an interface utilizing data from an SQL database, and wherein importing into the system comprises importing into an SQL database.

In a feature of this aspect, the patients are patients discharged from a medical facility.

In a feature of this aspect, the interface comprises a row which displays, for each respective column associated with a respective team, a count of action items or requests for communication which need to be attended to by the particular team, these counts being automatically updated by the system in response to user input.

In a feature of this aspect, the patients are patients discharged from a medical facility and wherein the calculated risk score comprises a calculated risk of readmission score.

In a feature of this aspect, the first electronic device comprises a touchscreen device, and the first user provides input via a touchscreen of the first electronic device.

In a feature of this aspect, the first electronic device comprises a computer, and the first user provides input via a mouse and keyboard associated with the first electronic device.

In a feature of this aspect, the second electronic device comprises a touchscreen device, and the second user provides input via a touchscreen of the second electronic device.

In a feature of this aspect, the second electronic device comprises a computer, and the second user provides input via a mouse and keyboard associated with the second electronic device.

In a feature of this aspect, the teams represent departments of a hospital.

In a feature of this aspect, the teams include a nursing team.

In a feature of this aspect, the teams include a pharmacy team.

In a feature of this aspect, the teams include a home health team.

In a feature of this aspect, the teams include a spiritual care team.

In a feature of this aspect, the teams include a palliative team.

In a feature of this aspect, rows associated with patients are sorted based at least in part on a respective discharge date for each patient.

In a feature of this aspect, rows associated with patients are sorted based at least in part on a respective unit each patient was disposed from to group patients disposed from the same unit together.

In a feature of this aspect, rows associated with patients are sorted based at least in part on a primary language each patient speaks to group patients who speak the same language together.

In a feature of this aspect, rows associated with patients are sorted based at least in part on a time of day each patient prefers to be contacted.

In a feature of this aspect, rows associated with patients are sorted first based on a respective discharge date, then based on a respective disposed from unit, then based on a respective primary language, then based on a respective preferred contact time of day, then based on a calculated risk score.

In a feature of this aspect, cells in the interface are color coded to quickly convey information.

In a feature of this aspect, data in cells in the interface is color coded to quickly convey information.

In a feature of this aspect, the interface is configured to effect display of a menu of available actions by effecting display of a dropdown menu.

Another aspect relates to a method for facilitating coordination between teams concerned with entities, the method comprising importing, into a system, data for a plurality of entities; displaying, to a first user via a display of a first electronic device, an interface comprising a plurality of rows and a plurality of columns, the interface comprising data imported into the system, and the rows including a plurality of rows each corresponding to a particular entity, wherein the columns include a plurality of columns each corresponding to a particular one of the teams concerned with the entities, and for each respective cell lying in a respective row associated with a respective entity and in a respective column associated with a respective team, the interface is configured to allow for both display in the respective cell of a status message indicating a status of actions by the respective team with respect to the respective entity, and user interaction with the respective cell which effects display of a menu of available actions that can be requested of the respective team with respect to the respective entity, and effects selection of one of the available actions, wherein user selection of an available action effects updating in the interface of a displayed status message for the respective cell, and the columns include a column containing a calculated risk score, rows associated with an entity are sorted based at least in part on respective calculated risk scores for each entity to prioritize communications with entities having a greater risk; receiving, from the first user via one or more input devices associated with the first electronic device, input corresponding to interaction with a first respective cell associated with a first respective entity and a first respective team, such input representing a request to undertake an action with respect to the first respective entity by the first respective team; updating, based on the received user input representing a request, the first respective cell of the interface to indicate the request; displaying, to a second user via a display of a second electronic device, the updated interface including the indication of the request in the first respective cell; receiving, from the second user via one or more input devices associated with the second electronic device, input corresponding to interaction with the first respective cell, such input representing an indication of a status of action with respect to the first respective entity by the first respective team; updating, based on the received user input representing an indication of a status of action with respect to the first respective entity by the first respective team, the first respective cell to reflect such status; displaying, to the first user via the display of the first electronic device, the updated interface including the indicated status of action in the first respective cell.

In a feature of this aspect, a team may represent a single person.

In a feature of this aspect, a team comprises one or more people.

In a feature of this aspect, an entity comprises a real estate property.

In a feature of this aspect, an entity comprises a real estate deal.

In a feature of this aspect, an entity comprises a deal.

Another aspect relates to a method for facilitating coordination between teams concerned with entities, the method comprising importing, into a system, data for a plurality of entities; displaying, to a first user via a display of a first electronic device, an interface comprising a plurality of rows and a plurality of columns, the interface comprising data imported into the system, and the rows including a plurality of rows each corresponding to a particular entity, wherein the columns include a plurality of columns each corresponding to a particular one of the teams concerned with the entities, and for each respective cell lying in a respective row associated with a respective entity and in a respective column associated with a respective team, the interface is configured to allow for both display in the respective cell of a status message indicating a status of actions by the respective team with respect to the respective entity, and user interaction with the respective cell which effects display of a menu of available actions that can be requested of the respective team with respect to the respective entity, and effects selection of one of the available actions, wherein user selection of an available action effects updating in the interface of a displayed status message for the respective cell; receiving, from the first user via one or more input devices associated with the first electronic device, input corresponding to interaction with a first respective cell associated with a first respective entity and a first respective team, such input representing a request to undertake an action with respect to the first respective entity by the first respective team; updating, based on the received user input representing a request, the first respective cell of the interface to indicate the request; displaying, to a second user via a display of a second electronic device, the updated interface including the indication of the request in the first respective cell; receiving, from the second user via one or more input devices associated with the second electronic device, input corresponding to interaction with the first respective cell, such input representing an indication of a status of action with respect to the first respective entity by the first respective team; updating, based on the received user input representing an indication of a status of action with respect to the first respective entity by the first respective team, the first respective cell to reflect such status; displaying, to the first user via the display of the first electronic device, the updated interface including the indicated status of action in the first respective cell.

Another aspect relates to a system comprising one or more processors and one or more computer readable media containing computer executable instructions for performing a method for facilitating coordination between teams concerned with entities, the method comprising importing, into the system, data for a plurality of entities; displaying, to a first user via a display of a first electronic device, an interface comprising a plurality of rows and a plurality of columns, the interface comprising data imported into the system, and the rows including a plurality of rows each corresponding to a particular entity, wherein the columns include a plurality of columns each corresponding to a particular one of the teams concerned with the entities, and for each respective cell lying in a respective row associated with a respective entity and in a respective column associated with a respective team, the interface is configured to allow for both display in the respective cell of a status message indicating a status of actions by the respective team with respect to the respective entity, and user interaction with the respective cell which effects display of a menu of available actions that can be requested of the respective team with respect to the respective entity, and effects selection of one of the available actions, wherein user selection of an available action effects updating in the interface of a displayed status message for the respective cell; receiving, from the first user via one or more input devices associated with the first electronic device, input corresponding to interaction with a first respective cell associated with a first respective entity and a first respective team, such input representing a request to undertake an action with respect to the first respective entity by the first respective team; updating, based on the received user input representing a request, the first respective cell of the interface to indicate the request; displaying, to a second user via a display of a second electronic device, the updated interface including the indication of the request in the first respective cell; receiving, from the second user via one or more input devices associated with the second electronic device, input corresponding to interaction with the first respective cell, such input representing an indication of a status of action with respect to the first respective entity by the first respective team; updating, based on the received user input representing an indication of a status of action with respect to the first respective entity by the first respective team, the first respective cell to reflect such status; displaying, to the first user via the display of the first electronic device, the updated interface including the indicated status of action in the first respective cell.

Another aspect relates to a method for facilitating communication with patients discharged from a medical facility, the method comprising maintaining, in a shared network folder, a spreadsheet file comprising a first data sheet including a plurality of rows and a plurality of columns, the rows including a task count row proximate a top of the data sheet, and a plurality of rows therebelow each corresponding to a discharged patient, and the columns comprising a first column for storing a name of a respective patient, a second column for storing a medical records number associated with the respective patient, a third column for storing an indication of a discharge date associated with the respective patient, a fourth column for storing an indication of a time of day the respective patient prefers to be contacted via telephone, a fifth column for storing an indication of whether the respective patient has consented to allow follow up contact via telephone, a sixth column for storing additional information or notes regarding consent by the respective patient to allow follow up contact via telephone, a seventh column for storing an indication of a disposition following discharge for the respective patient, an eighth column for storing an indication of a readmission risk score for the respective patient, a ninth column for storing an indication of a risk of developing sepsis for the respective patient, a tenth column for storing an indication of an infection risk for the respective patient, an eleventh first column including cells configured to provide a dropdown menu listing disciplines of a plurality of disciplines in order to access referrer information for a selected discipline, a twelfth column configured to automatically display, for the respective patient in response to selection in the twenty first column of a particular discipline, information regarding a last referral to the selected particular discipline, for each respective discipline of a plurality of disciplines, a respective column for facilitating communications between the respective discipline and the respective patient, cells in each respective column being configured to provide a dropdown menu for requesting follow up by the discipline or indicating a status of follow up by the discipline, and a second data sheet configured to allow for importing of discharge data, the second data sheet comprising a plurality of columns configured to correspond to data fields of a medical software program; importing, by a first user, discharge data for a plurality of discharged patients from the medical software program by pasting data from the medical software program into the second data sheet configured to allow for importing of discharge data, automatically updating the first data sheet based on the imported discharge data pasted into the second data sheet, such automatic updating including adding a row for each of a plurality of newly discharged patients in the imported data for which a row was not already present in the first data sheet, automatically, based on imported data for one of the newly discharged patients, determining that follow up contact is needed from a first discipline of the plurality of disciplines, and, based thereon, updating the respective column corresponding to the first discipline to indicate a referral to the respective discipline, such updating including updating a value and color of the cell corresponding to the respective discipline and the one of the newly discharged patients, and updating a value of the task count row to take into account the required contact.

In a feature of this aspect, the disciplines include a nursing discipline. In one or more implementations, the columns of the first sheet further include a column for storing information regarding a first date nursing contacted the respective patient. In one or more implementations, wherein the columns of the first sheet further include a column for storing information regarding a next date that nursing should attempt contact with the respective patient. In one or more implementations, the dropdown menu provided in the cells in the respective column for the nursing discipline includes a general ‘Nursing’ value to indicate that contact with the respective patient is required. In one or more implementations, the ‘Nursing’ value is color coded teal. In one or more implementations, the dropdown menu provided in the cells in the respective column for the nursing discipline includes a ‘Repeat’ value to indicate that another contact with the respective patient is required. In one or more implementations, the ‘Repeat’ value is color coded dark teal. In one or more implementations, the dropdown menu provided in the cells in the respective column for the nursing discipline includes a ‘Done’ value to indicate that requested or required contact with the respective patient has been completed. In one or more implementations, the ‘Done’ value is color coded white. In one or more implementations, the dropdown menu provided in the cells in the respective column for the nursing discipline includes a ‘Nurse A’ value to indicate that a first nurse on duty should contact the respective patient. In one or more implementations, the ‘Nurse A’ value is color coded teal. In one or more implementations, the dropdown menu provided in the cells in the respective column for the nursing discipline includes a ‘Nurse B’ value to indicate that a second nurse on duty should contact the respective patient. In one or more implementations, the ‘Nurse B’ value is color coded teal. In one or more implementations, the dropdown menu provided in the cells in the respective column for the nursing discipline includes a ‘Delay Call’ value to indicate that a call to the respective patient should be delayed a certain number of days. In one or more implementations, the ‘Delay Call’ value is color coded orange. In one or more implementations, the dropdown menu provided in the cells in the respective column for the nursing discipline includes a ‘Computer Call’ value to indicate that an automated call is to be placed to the respective patient. In one or more implementations, the ‘Computer Call’ value is color coded brown. In one or more implementations, the dropdown menu provided in the cells in the respective column for the nursing discipline includes a ‘Wrong Number’ value to indicate that a contact number for the respective patient was utilized but appears to be a wrong number. In one or more implementations, the dropdown menu provided in the cells in the respective column for the nursing discipline includes an ‘Attempt 1’ value to indicate that an unsuccessful first attempt to contact the respective patient has been made. In one or more implementations, the ‘Attempt 1’ value is color coded teal. In one or more implementations, the dropdown menu provided in the cells in the respective column for the nursing discipline includes an ‘Attempt 2’ value to indicate that an unsuccessful second attempt to contact the respective patient has been made. In one or more implementations, the ‘Attempt 2’ value is color coded teal. In one or more implementations, the dropdown menu provided in the cells in the respective column for the nursing discipline includes an ‘Attempt 3’ value to indicate that an unsuccessful third attempt to contact the respective patient has been made. In one or more implementations, the ‘Attempt 3’ value is color coded white.

Another aspect relates to a system configured to receive user input to facilitate tracking when patients have been called after release from a hospital.

Another aspect relates to a system configured to receive user input to facilitate tracking when patients have been called after release from a hospital, and notify other parties that calls need to be made based upon the outcome of a first call.

Another aspect relates to a system configured to receive user input to facilitate tracking when patients have been called after release from a hospital, and notify other parties that a call needs to be made.

Another aspect relates to a system for performing a disclosed method.

Another aspect relates to one or more computer readable media containing computer executable instructions for performing a disclosed method.

In addition to the aforementioned aspects and features of the present invention, it should be noted that the present invention further encompasses the various possible combinations and subcombinations of such aspects and features. Thus, for example, any aspect may be combined with an aforementioned feature in accordance with the present invention without requiring any other aspect or feature.

### BRIEF DESCRIPTION OF THE DRAWINGS

One or more preferred embodiments of the present invention now will be described in detail with reference to the accompanying drawings, wherein the same elements are referred to with the same reference numerals, and wherein:

FIG. 1 illustrates an exemplary interface of a system in accordance with one or more preferred implementations;

FIG. 2 illustrates an exemplary interface displaying options for selection via a dropdown menu;

FIG. 3 illustrates updating of an interface to indicate a request;

FIGS. 4-5 illustrate updating of an interface to indicate that a requested follow up has been performed;

FIGS. 6-7 illustrate updating of an interface to request follow up by a nursing team;

FIGS. 8-9 illustrate exemplary updating of an interface to indicate a particular team member which should engage in communications;

FIG. 10 illustrates an indication that a first attempt has been made;

FIG. 11 illustrates an exemplary interface in which a count value is displayed in a row;

FIGS. 12-13 illustrate updating of a count value upon a requested communication being marked as done;

FIG. 14 illustrates an exemplary interface including columns for displaying a last referring team, a last referring user, and a last referred date and time;

FIGS. 15-16 illustrate an exemplary interface including a dropdown menu configured to allow for selection of a team to display referrer information for;

FIG. 17 illustrates an exemplary interface in which columns associated with a nursing team are updated to indicate a patient is high risk and needs more than one call;

FIG. 18 illustrates updating of columns associated with a nursing team and a home health team based on a disposition to home health;

FIG. 19 illustrates an exemplary interface in which a column associated with a nursing team is updated to indicate a patient is high risk and needs more than one call;

FIGS. 20-22 illustrate example architecture for an exemplary implementation in which a user accesses a web portal of a platform via a laptop or other computing device;

FIG. 23 illustrates an exemplary interface sorting patients by a risk of readmission score; and

FIG. 24 illustrates an exemplary interface sorting patients based on a unit from which they were disposed.

### DETAILED DESCRIPTION

As a preliminary matter, it will readily be understood by one having ordinary skill in the relevant art (“Ordinary Artisan”) that the present invention has broad utility and application. As should be understood, any embodiment may incorporate only one or a plurality of the above-disclosed aspects of the invention and may further incorporate only one or a plurality of the above-disclosed features. Furthermore, any embodiment discussed and identified as being “preferred” is considered to be part of a best mode contemplated for carrying out the present invention. Other embodiments also may be discussed for additional illustrative purposes in providing a full and enabling disclosure of the present invention. As should be understood, any embodiment may incorporate only one or a plurality of the above-disclosed aspects of the invention and may further incorporate only one or a plurality of the above-disclosed features. Moreover, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended, nor is to be construed, to limit the scope of patent protection afforded the present invention in any claim of a patent issuing here from, which scope is to be defined by the claims and the equivalents thereof. It is not intended that the scope of patent protection afforded the present invention be defined by reading into any claim a limitation found herein that does not explicitly appear in the claim itself

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection afforded the present invention is to be defined by the issued claim(s) rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

Regarding applicability of 35 U.S.C. 112, paragraph 6 or subsection (f), no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese or crackers” describes “a picnic basket having cheese without crackers”, “a picnic basket having crackers without cheese”, and “a picnic basket having both cheese and crackers.” Finally, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

Referring now to the drawings, one or more preferred embodiments of the present invention are next described. The following description of one or more preferred embodiments is merely exemplary in nature and is in no way intended to limit the invention, its implementations, or uses.

As noted above, hospital administrators sometimes have nurses make follow up calls to check on the status of patients, but one problem that sometimes emerges is that staff tasked with follow up communications do not necessarily know who else may have already followed up.

For example, there may be multiple departments, teams, or entities that wish to engage in follow up communications with a patient following discharge, such as a nursing team, a pharmacy team, and a home health team.

In accordance with one or more preferred implementations, a system is utilized to schedule, monitor, track, and/or request such communications. In accordance with one or more preferred implementations, a system is utilized to track when patients have been called after release from a hospital, and notify other parties that calls need to be made based upon the outcome of a first call.

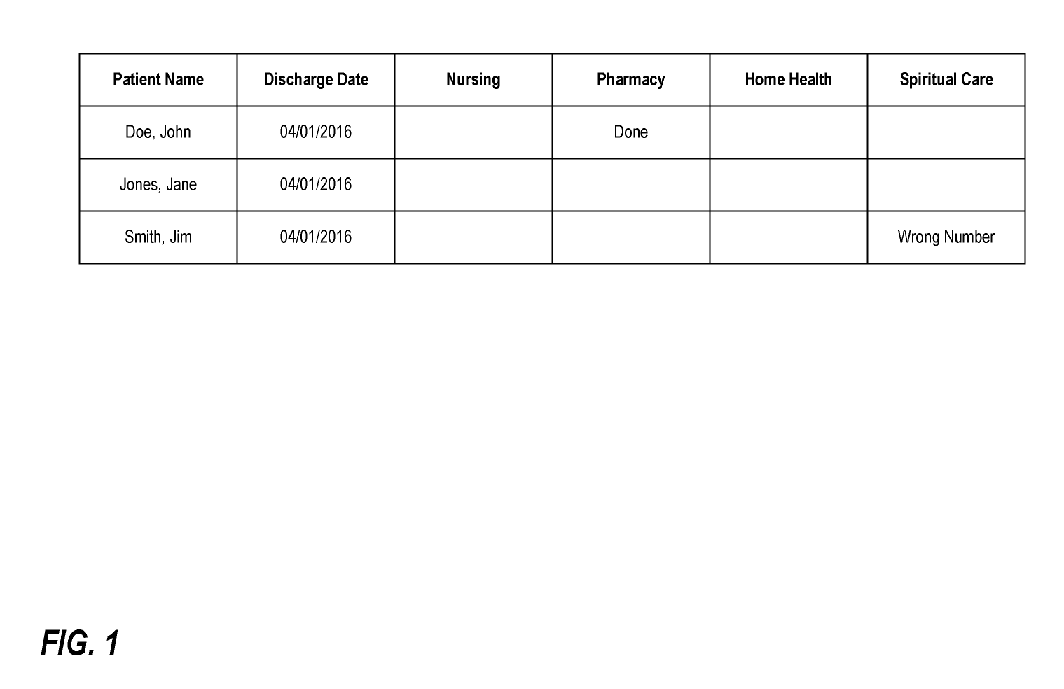

FIG. 1 illustrates an exemplary interface of a system in accordance with one or more preferred implementations. The interface comprises a plurality of rows and a plurality of columns. Aside from the header rows, the rows generally each represent data for a different, particular patient. The columns include columns that are associated with a particular team or department. For example, FIG. 1 illustrates rows for patients John Doe, Jane Jones, and Jim Smith, and columns for a nursing team, a pharmacy team, a home health team, and a spiritual care team.

Conventionally, each of these teams may have their own systems or processes for keeping track of communications with discharged patients, but these systems generally would not offer any visibility to those outside of the team, e.g. other teams. Systems in accordance with one or more preferred implementations provide an interface that offers visibility for each team into communications made by other teams.

Returning to the example of FIG. 1, the interface indicates that a call to John Doe has been completed by the pharmacy team, and that the spiritual care team attempted to contact Jim Smith but the number they called appears to have been a wrong number. This can be very useful for teams to have visibility into communications and communication attempts by other team. For example, the nursing team might be concerned that John Doe follow up with the pharmacy team regarding a prescription he was given. Absent knowledge that the pharmacy team has already followed up with John Doe, they might contact John Doe to inform him that he should follow up with the pharmacy team, or contact the pharmacy team to request a follow up with John Doe. However, with knowledge that the pharmacy team has already followed up with John Doe, the nursing team would not have to do so, confident that such follow up has already occurred.

In accordance with one or more preferred implementations, however, an interface of a system is useful not only for conveying information regarding communications that have occurred, but even for requesting communications or actions to be performed.

For example, the nursing team may be satisfied that the pharmacy team has been in contact with John Doe based on the indication in the interface of FIG. 1, but the nursing team may still be concerned about follow up by the pharmacy team with Jane Jones.

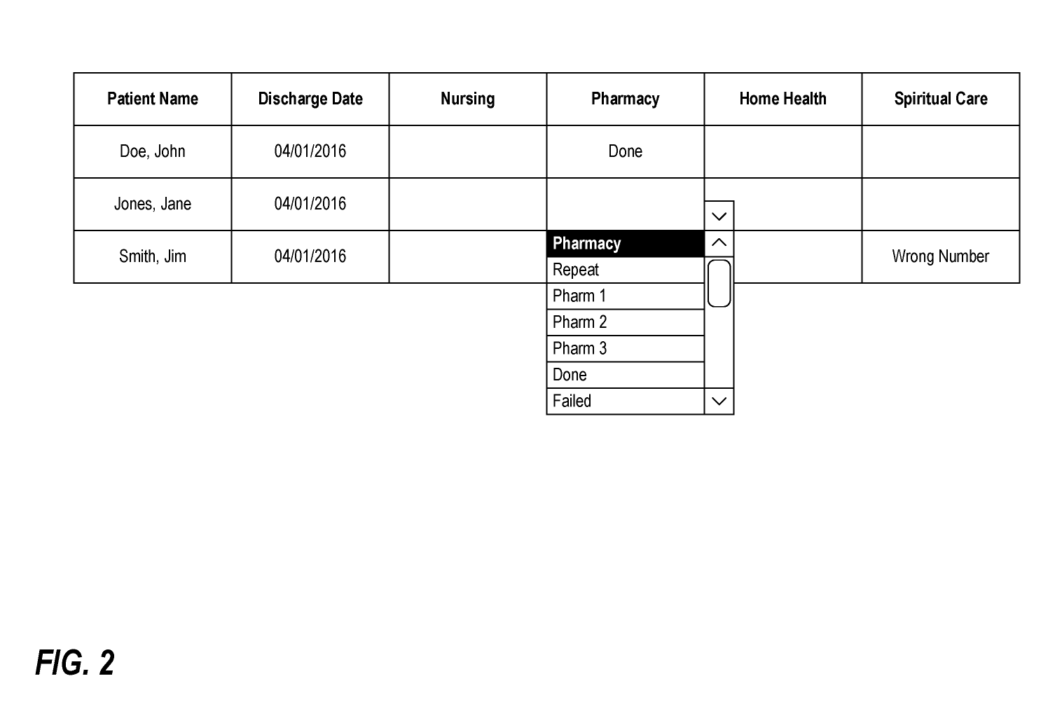

In accordance with one or more preferred implementations, an interface for coordinating communications among multiple teams is configured to provide a menu of options for requests to another team. For example, a member of the nursing team who is interacting with the interface of FIG. 1 can click or tap in the cell corresponding to Jane Jones and the pharmacy team and effect display of a dropdown menu of options for selection. FIG. 2 illustrates an exemplary interface displaying such options. It will be appreciated that the illustrated and discussed options are exemplary only, and that any options and option labels may be utilized to best allow for service requests to be made and information to be communicated.

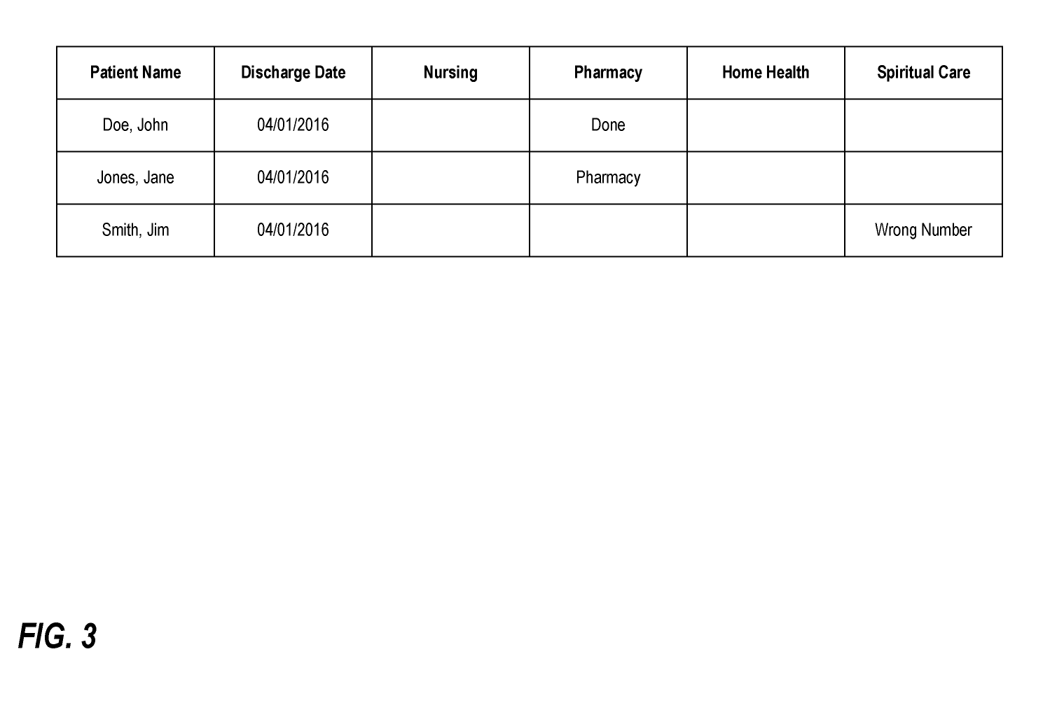

In this example, the nursing team member can select a “Pharmacy” option to request a follow up communication for Jane Jones from the pharmacy team. FIG. 3 illustrates updating of the interface to indicate this request.

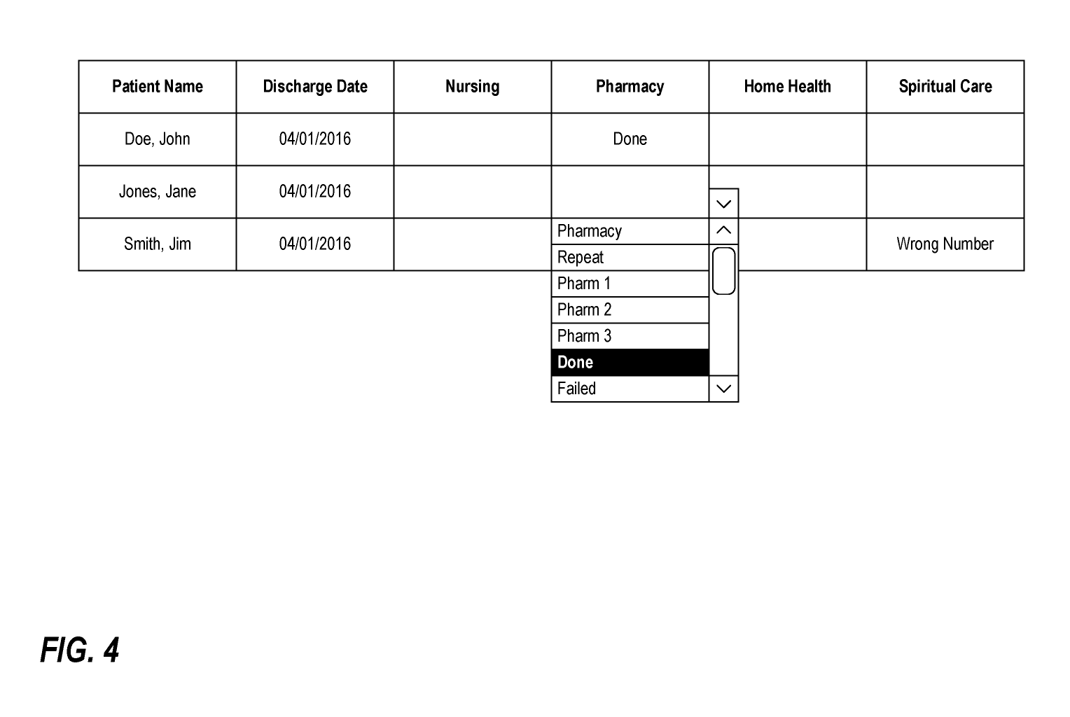

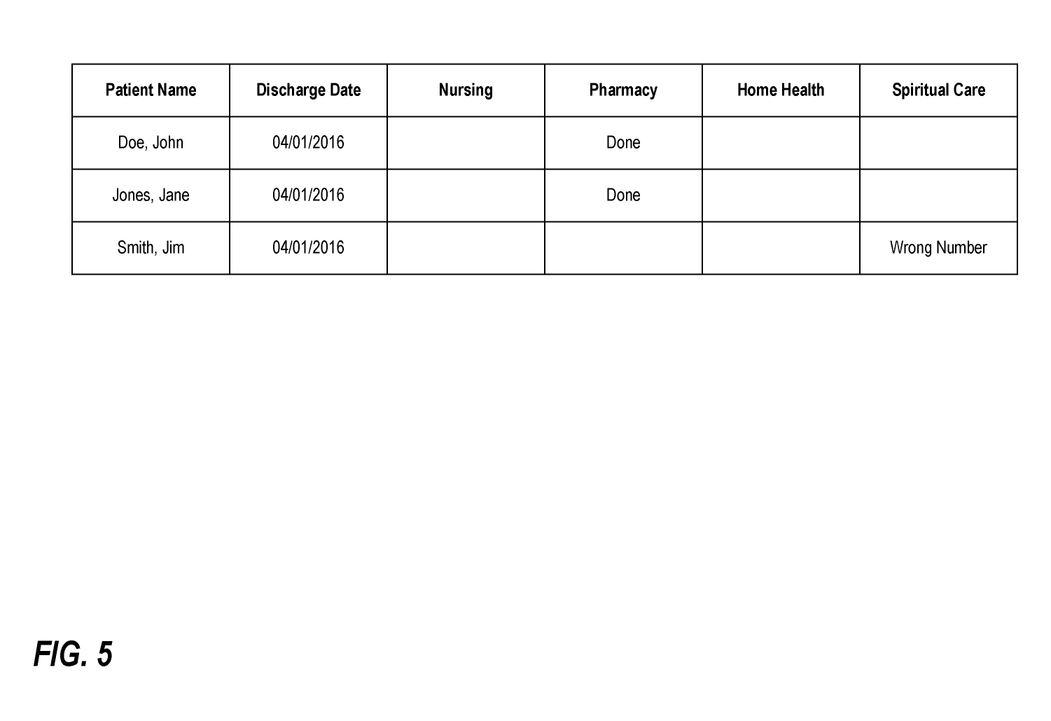

Subsequently, the pharmacy team can access an interface of the system which displays the same data as viewed by the nursing team. A member of the pharmacy team can see the request to call Jane Jones, and conduct a follow up call with Ms. Jones. After completing this task, the member of the pharmacy team can interact with the interface to indicate that the requested call has been completed. FIGS. 4-5 illustrate updating of the interface to indicate that the requested follow up with Jane Jones has been performed.

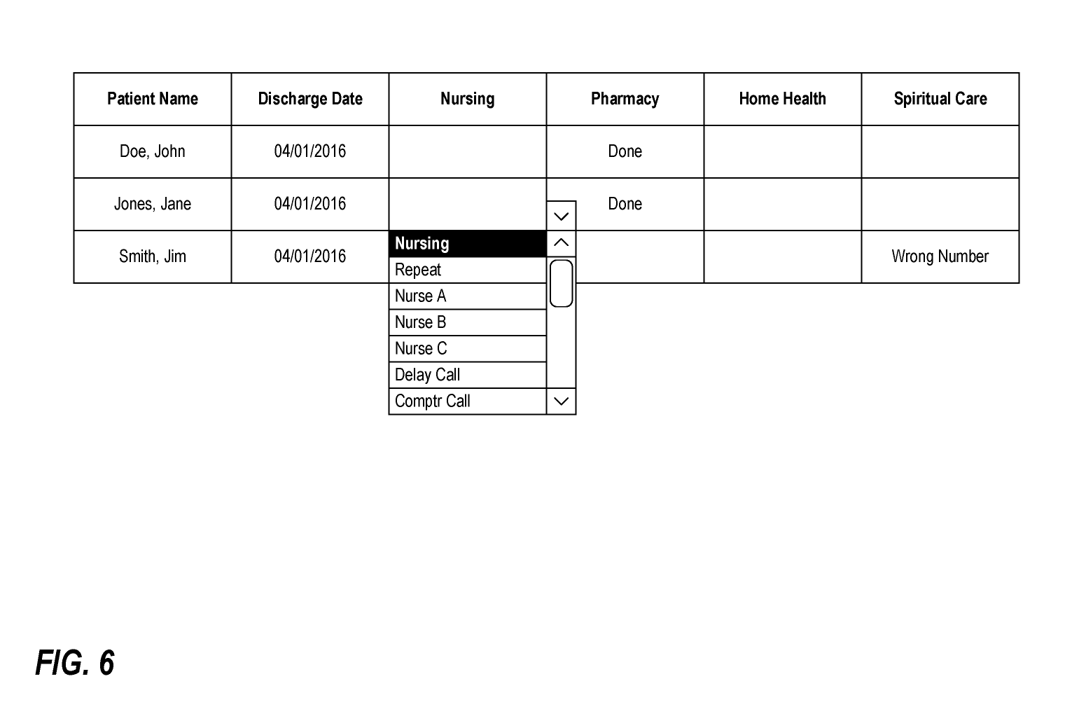

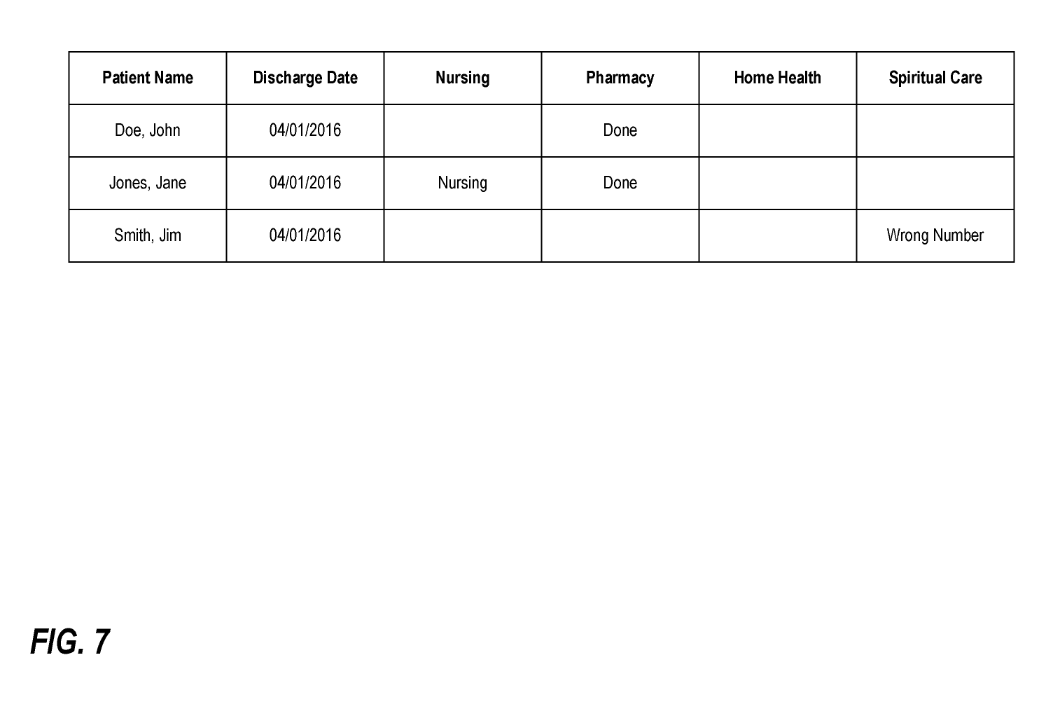

During the call, the pharmacy team member may have learned that Ms. Jones has a question and desires to speak with a member of the nursing team. To facilitate this, the pharmacy team member can utilize the system to request that the nursing team contact Ms. Jones. FIGS. 6-7 illustrate updating of the interface to request follow up by the nursing team.

In addition to coordinating communications between different teams, systems in accordance with one or more preferred implementations can also be utilized to coordinate communications and activities internally within a team.

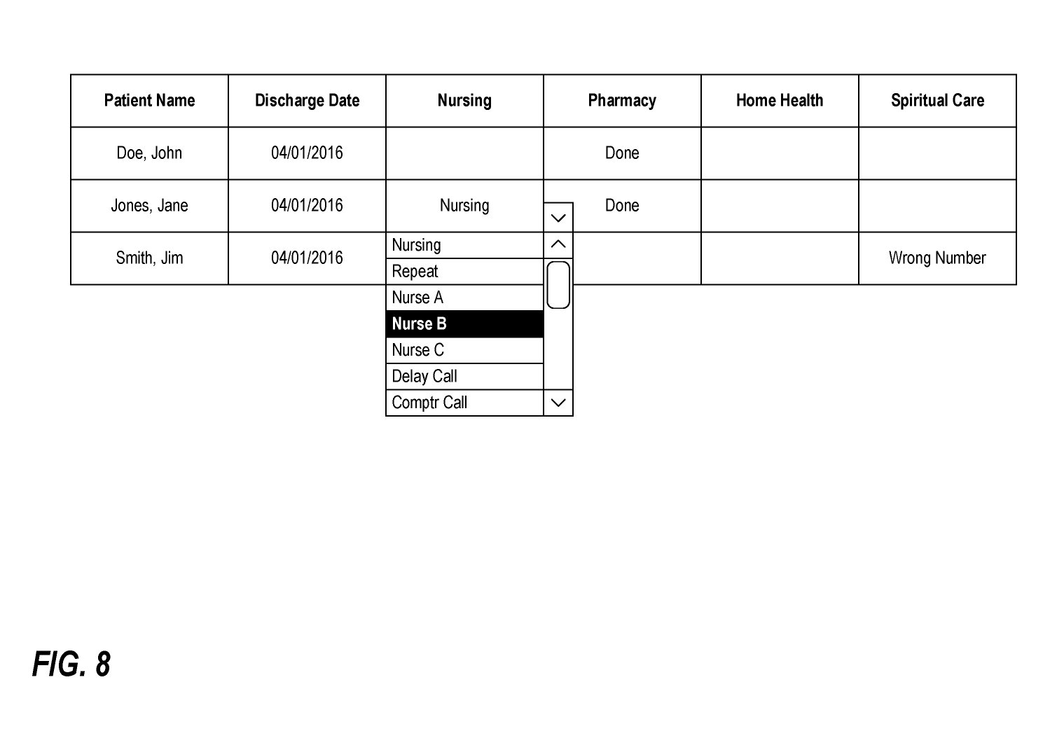

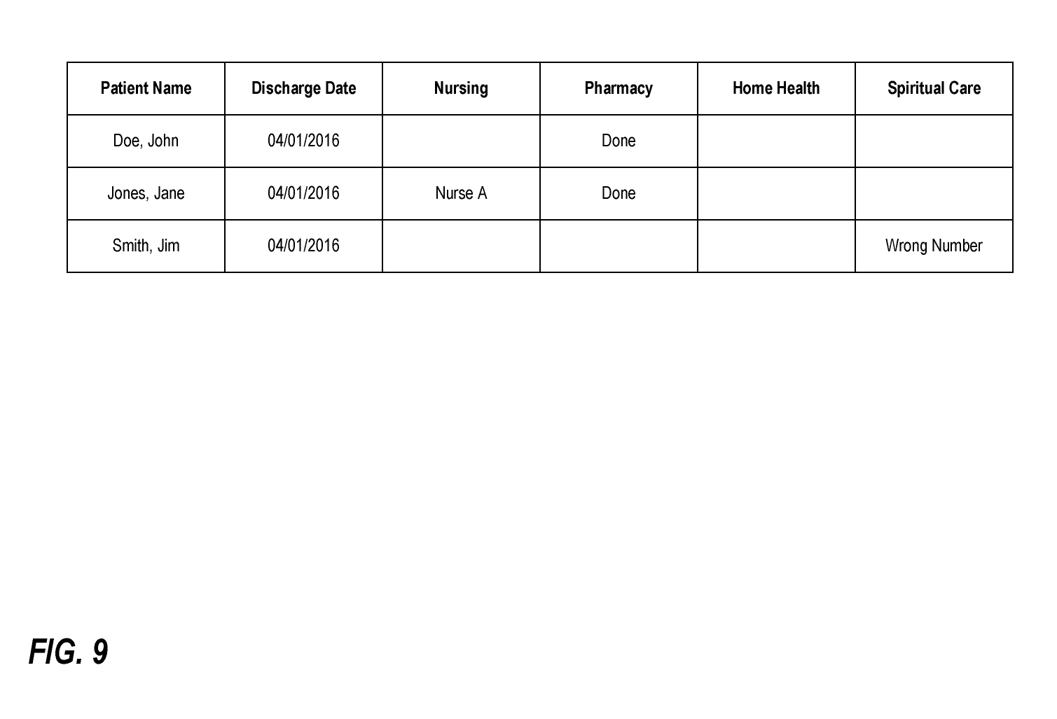

For example, an exemplary interface such as the one illustrated in FIG. 7 may be utilized by members of a team such as the nursing team as a daily action item list indicating patients for which follow up communication is necessary. An interface of a system in accordance with one or more preferred implementations may be configured to allow a team to assign tasks or action items to a particular member of the team. For example, if a nursing team generally has three members on duty, an interface of a system might be configured to allow a member of the nursing team or a supervisor or manager to update the interface to indicate a particular member which should conduct a follow up communication. FIGS. 8-9 illustrate exemplary such updating of an interface to indicate a particular team member which should engage in communications. The system may be configured to allow for selection and display of a particular team member's name, or alternatively or additionally may be configured to allow for selection of a particular role, e.g. three on duty nurses may be assigned roles as Nurse A, Nurse B, and Nurse C. In accordance with one or more preferred implementations, internal updating of an interface to indicate a particular team member that should engage in communications helps guard against repeat communications to the same patient by different members of the team.

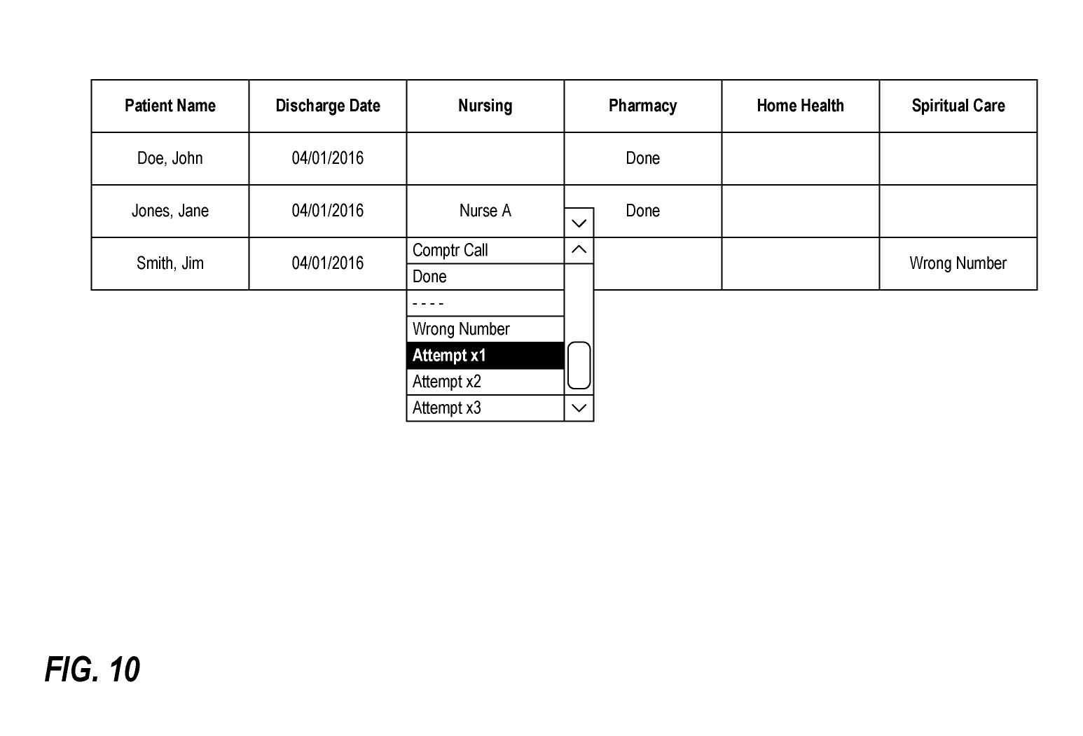

In accordance with one or more preferred implementations, an interface of a system is configured to allow for indication of status information regarding a request. For example, Nurse A may conduct the requested call to Jane Jones, but find that no one answers and learn that the voice mail box is full. In this case, Nurse A may indicate in the interface that a first attempt has been made and that another subsequent attempt should later be made. FIG. 10 illustrates such an indication that a first attempt has been made. If multiple attempts are made without successful contact, it may be determined that an alternative method of contact, such as a letter, may be required instead. In accordance with one or more preferred implementations, a request to contact a patient may be removed as an action item after repeated failed attempts, e.g. after three failed attempts.

In accordance with one or more preferred implementations, additional columns may be utilized to track data related to communications from a team. For example, an interface may include a column indicating a date of first contact by the nursing team, and a column indicating the date for a next call to be placed by the nursing team.

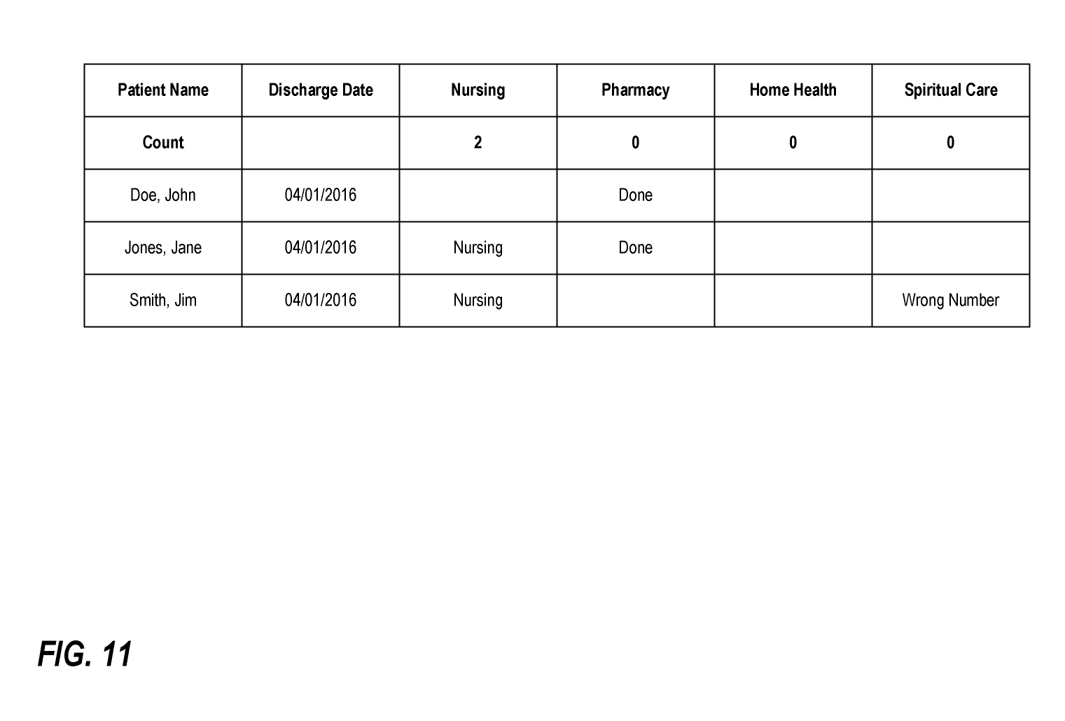

As noted above, an exemplary interface such as the ones illustrated may be utilized by members of a team such as a nursing team as a daily action item list indicating tasks which need to be performed, e.g. patients for which follow up communication is necessary. In accordance with one or more preferred implementations, an interface of a system is configured to display a count of tasks which need to be completed. FIG. 11 illustrates an exemplary interface in which a count value is displayed in a row.

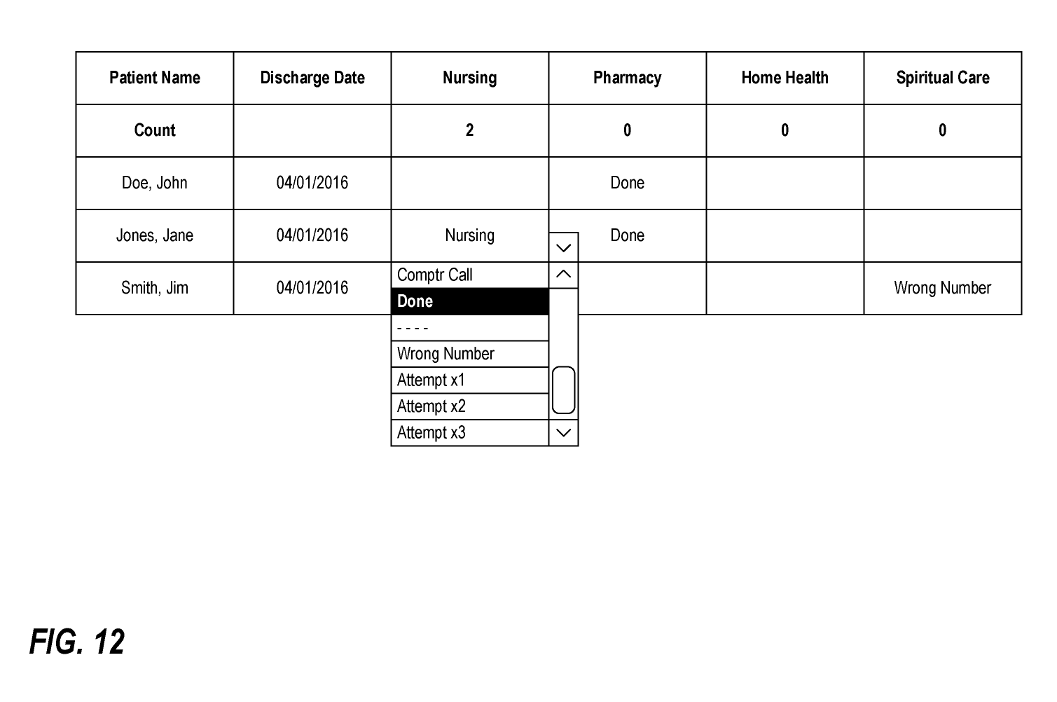

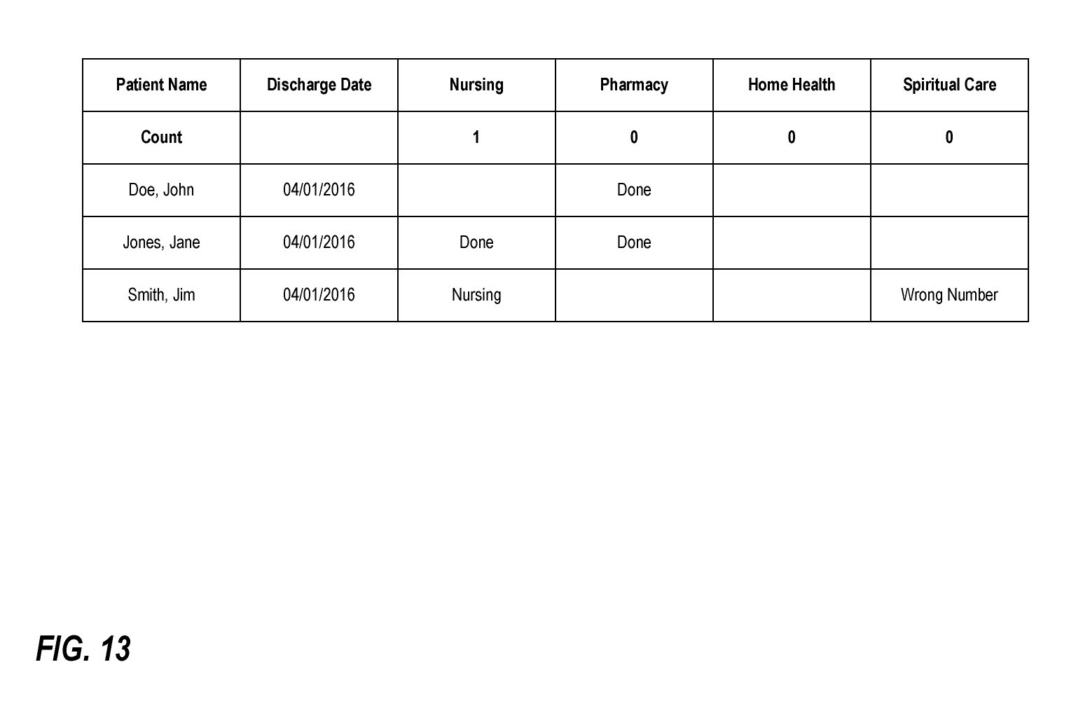

Preferably, once a task has been completed and marked as such using the interface, the count will update to indicate this. FIGS. 12-13 illustrate updating of a count value upon a requested communication being marked as done.

In accordance with one or more preferred implementations, an interface of a system is configured to provide additional information regarding requests for service from other teams.

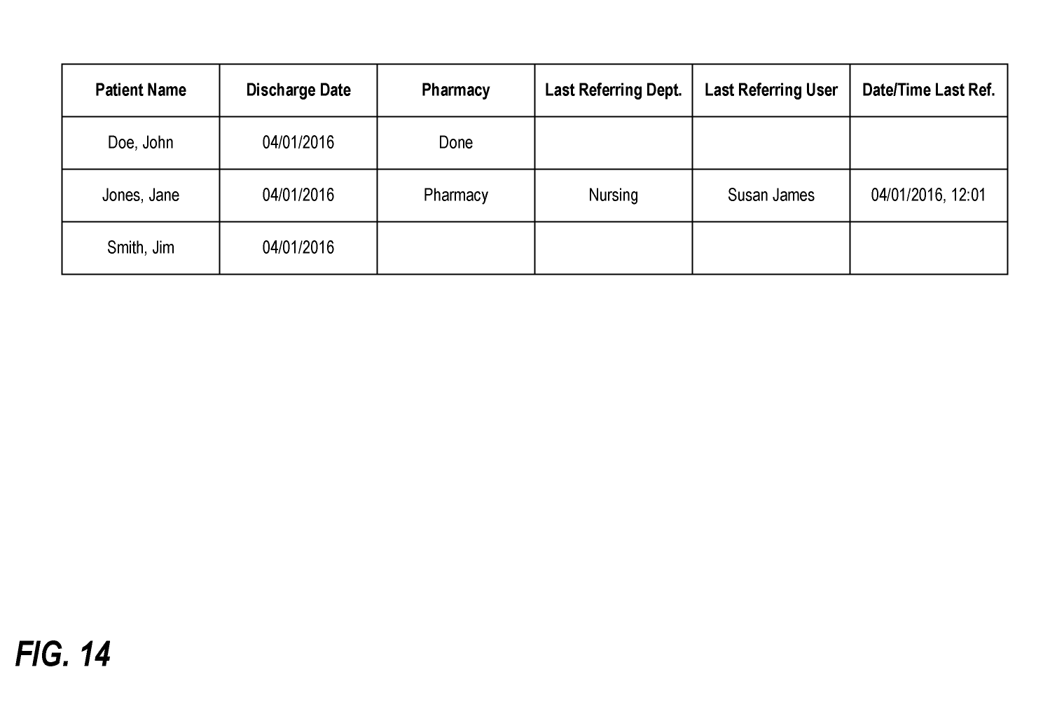

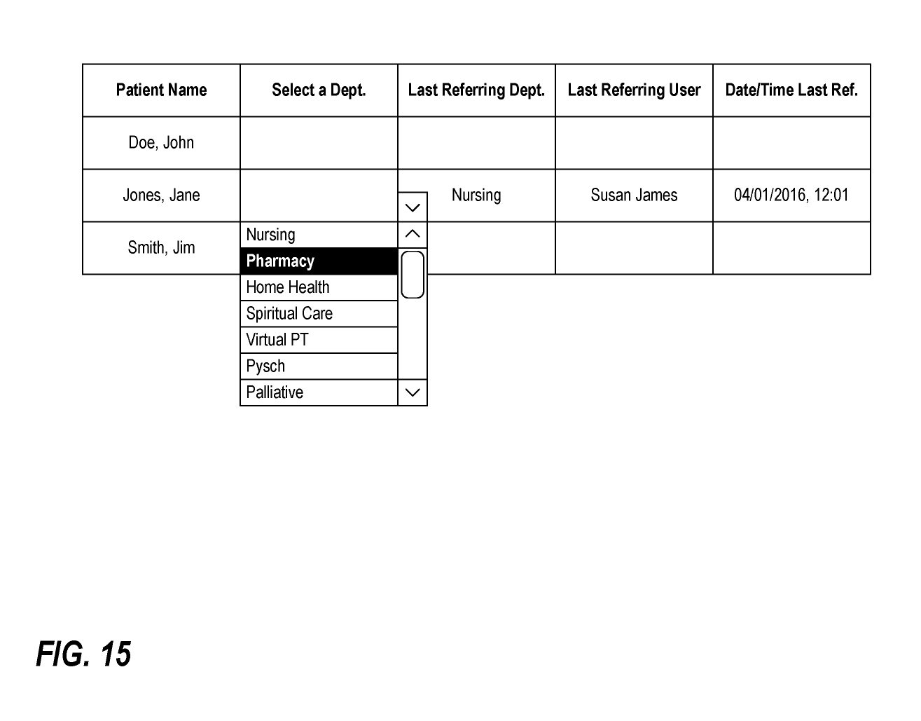

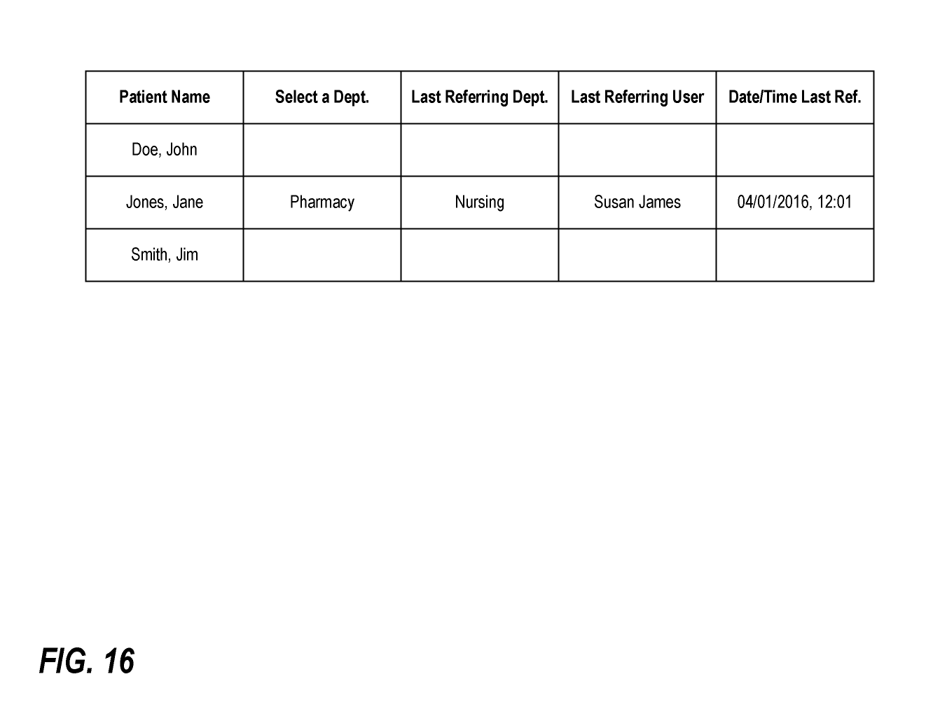

For example, each team may have a column that displays information regarding the last referrer to that team. FIG. 14 illustrates an exemplary interface including columns for displaying a last referring team, a last referring user, and a last referred date and time. Alternatively, in one or more preferred implementations, an interface may be configured to have a column which provides a drop down menu to select a particular team, and then display referrer information for that team. FIGS. 15-16 illustrate an exemplary interface including a dropdown menu configured to allow for selection of a team to display referrer information for.

In accordance with one or more preferred implementations, an interface of a system is configured to display other patient information, as well as patient status information. In accordance with one or more preferred implementations, an interface of a system is configured to display patient status information (e.g. whether a patient is an inpatient or outpatient), patient diagnosis information, age information, gender information, language information (e.g. what languages a patient speaks), and time preference information (e.g. what time of day the patient prefers to be contacted).

In accordance with one or more preferred implementations, an interface of a system is configured to display information regarding a unit a patient was discharged from, disposition information for the patient, and a calculated risk of readmission score.

In accordance with one or more preferred implementations, calculation of this risk of readmission score takes into account in the score a length of time from when a discharge request was placed, to when a discharged actually occurred.

In accordance with one or more preferred implementations, an interface of a system is configured to display information in a color coded manner to facilitate easy review and comprehension. For example, a column associated with a calculated risk of readmission score may be color coded to quickly indicate the relative risk of readmission of a patient with a bright red or orange color indicating a high risk of readmission, and a yellow color indicating a moderate risk of readmission. Other columns may similarly be color coded. Exemplary such color coding will be disclosed herein throughout.

In accordance with one or more preferred implementations, data (e.g. demographics, disposition, etc.) from one or more data sources (such as a Cerner system or an admission discharge transfer system) regarding patients that have been discharged on the previous calendar day is automatically or manually imported into the system and utilized to populate an interface of the system. Such data may, for example, be automatically imported or uploaded continuously, or overnight, or manually imported or uploaded every morning. Preferably, users of the system who are in contact with the patient after discharge have the capability of altering data in the system to keep information continually updated to reflect current best knowledge.

In accordance with one or more preferred implementations, imported or updated data, as well as user input of data, can be utilized to automatically trigger one or more actions.

For example, in one or more preferred implementations, a disposition of a patient is utilized to trigger updating of data and creation of new actions items throughout a system.

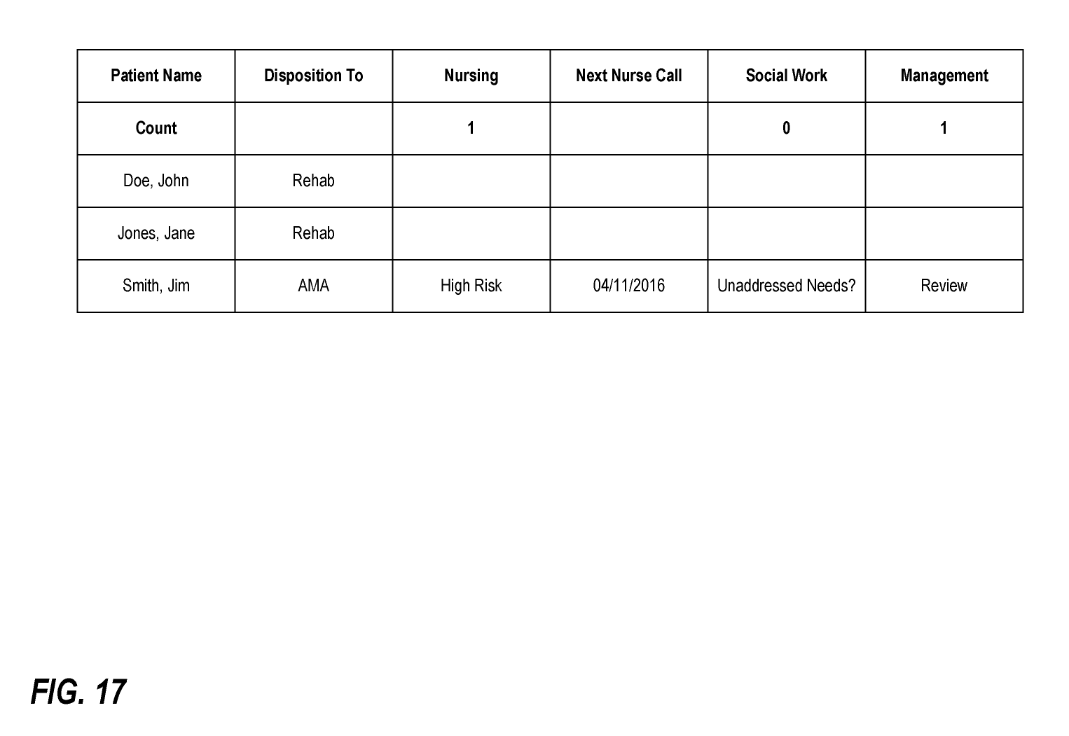

In accordance with one or more preferred implementations, a system is configured to support indication of an “AMA” disposition indicating that a patient left against medical advice. In accordance with one or more preferred implementations, such a disposition triggers updating of a column associated with a nursing team to indicate that a call is needed, and, based on the fact that a patient is high risk, preferably further triggers updating of a next nursing call column to indicate that the patient needs more than one call. FIG. 17 illustrates an exemplary interface in which columns associated with a nursing team are updated to indicate a patient is high risk and needs more than one call. Although the label “High Risk” is utilized, in one or more preferred implementations this would not be a separate label, and the label “Nursing” would simply be utilized together with the next nursing call column to indicate a further call will be needed. In accordance with one or more preferred implementations, a disposition of AMA may also trigger an alert to a home health team, and may further trigger a review by a social work and counseling team to see if the patient has unaddressed needs, as illustrated in FIG. 17. In accordance with one or more preferred implementations, this suggestion for review is treated as a “soft request” which does not count towards a total count value associated with tasks for a team (as illustrated in FIG. 17, in which the “Unaddressed Needs” alert is not counted), as compared to a “hard request” which does.

An AMA disposition may also trigger a review by a manager or supervisor (or associated team) to see if there was something that upset the patient or could have been done better. Such alerts and reviews may be indicated in an appropriate column of an interface of the system, as illustrated in FIG. 17. These may or may not be count toward an action item count for a management team.

In accordance with one or more preferred implementations, a system is configured to support indication of a “Home” disposition indicating that a patient was discharged to his home. In accordance with one or more preferred implementations, this disposition triggers an indication for the nursing team to initiate a follow up communication, e.g. by updating a column associated with the nursing team. In accordance with one or more preferred implementations, a Home disposition also raises a red flag for a pharmacy team.

In accordance with one or more preferred implementations, an event associated with a particular team may trigger an action item or alert for another team. Additionally, such triggering may be conditional on patient data, e.g. conditional on a disposition of the patient.

For example, in accordance with one or more preferred implementations, if a patient has a disposition of Home, a failure at the home health team indicated in an interface of the system may trigger an action item for a chronic disease counselor team and a manager, supervisor, or associated team.

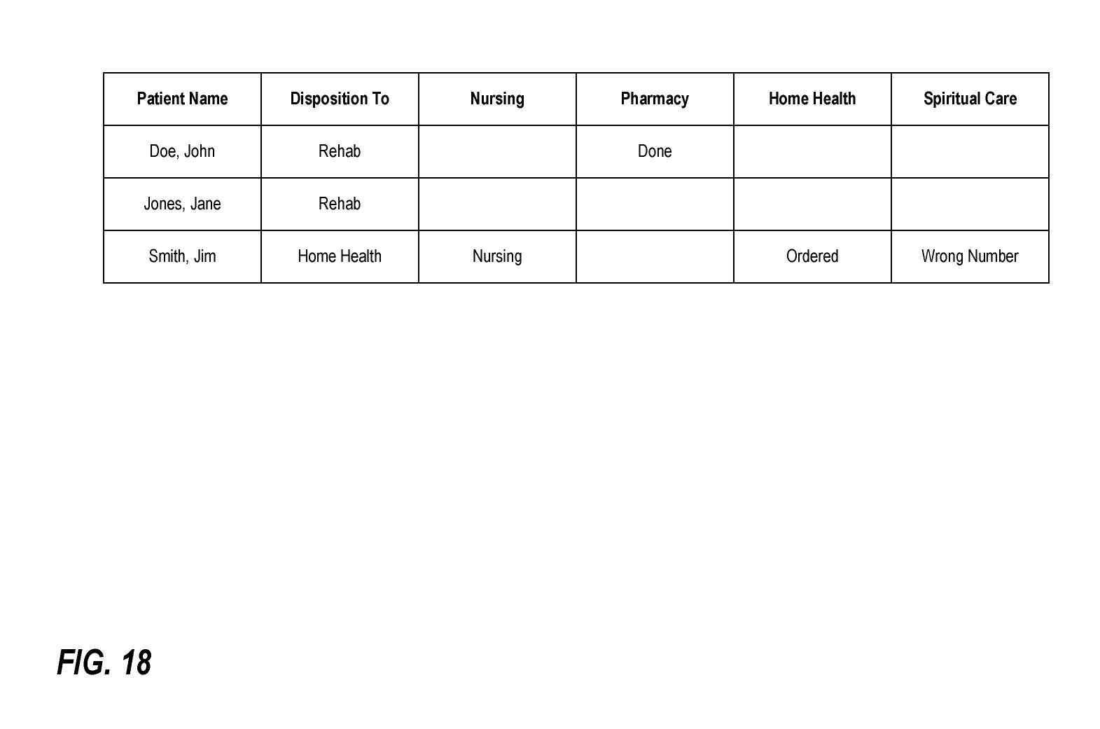

In accordance with one or more preferred implementations, a system is configured to support indication of a “Home Health” disposition. This disposition may trigger an indication for the nursing team to initiate a follow up communication, e.g. by updating a column associated with the nursing team. This disposition may further trigger an indication for the home health team that an order is waiting. FIG. 18 illustrates updating of columns associated with a nursing team and a home health team based on a disposition to home health.

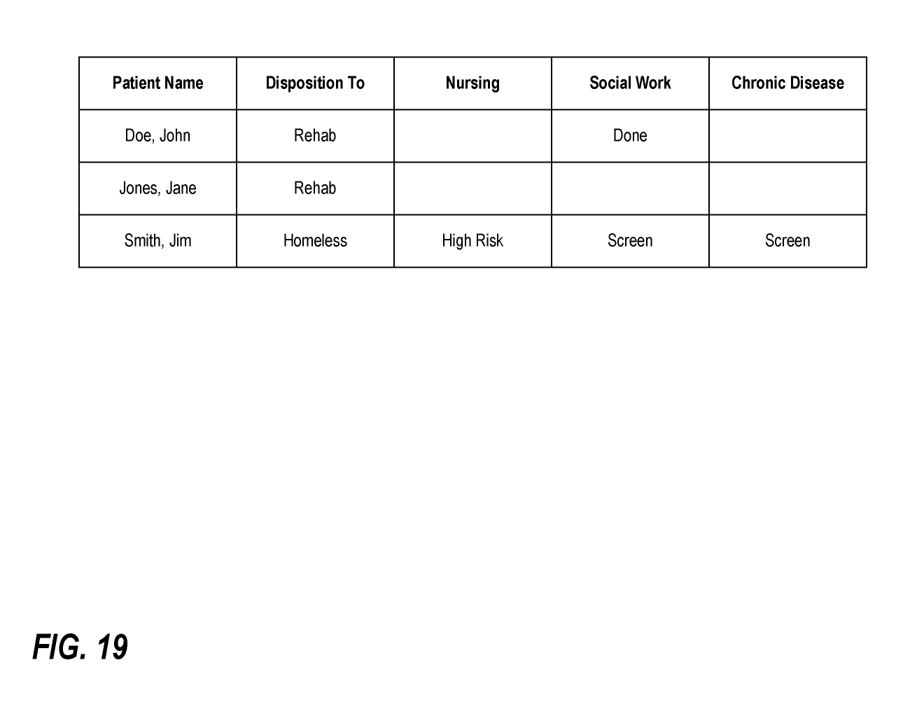

In accordance with one or more preferred implementations, a system is configured to support indication of a “Homeless” disposition indicating that a discharged patient is homeless. In accordance with one or more preferred implementations, such a disposition triggers updating of a column associated with a nursing team to indicate that the patient is high risk and needs more than one call. FIG. 19 illustrates an exemplary interface in which a column associated with a nursing team is updated to indicate a patient is high risk and needs more than one call. In accordance with one or more preferred implementations, a Homeless disposition further raises a red flag for a pharmacy team and triggers an indication for a social work and counseling team and a chronic disease counseling team to screen the patient's case.

In accordance with one or more preferred implementations, a system further includes a “Deceased” disposition which triggers an indication to a spiritual care team that a follow up communication is needed (e.g. to a patient's family two weeks after a patient's death), and may also trigger cancelation of any outstanding follow up communications scheduled or requested for other teams.

In accordance with one or more preferred implementations, a system further includes a “Readmitted” disposition, which may trigger an indication to one or more in-hospital teams that the patient has been readmitted, and also may trigger cancelation of one or more outstanding follow up communications scheduled or requested.

In accordance with one or more preferred implementations, a system further includes a “Shelter” disposition (which triggers an indication to a nursing team that the patient is high risk), an “Assisted Living” disposition (which triggers an indication to a nursing team that follow up communication is needed and which triggers an alert for a home health team), a “Psych Hospital” disposition (which triggers an indication to a nursing team that a delayed call is needed and sets an alarm reminder, also triggers a review of medication and potential use of special packaging by a pharmacy team, and further triggers an indication to a social work and counseling team that a follow up communication is needed), a “Jail” disposition”, and a “Rehab” disposition.

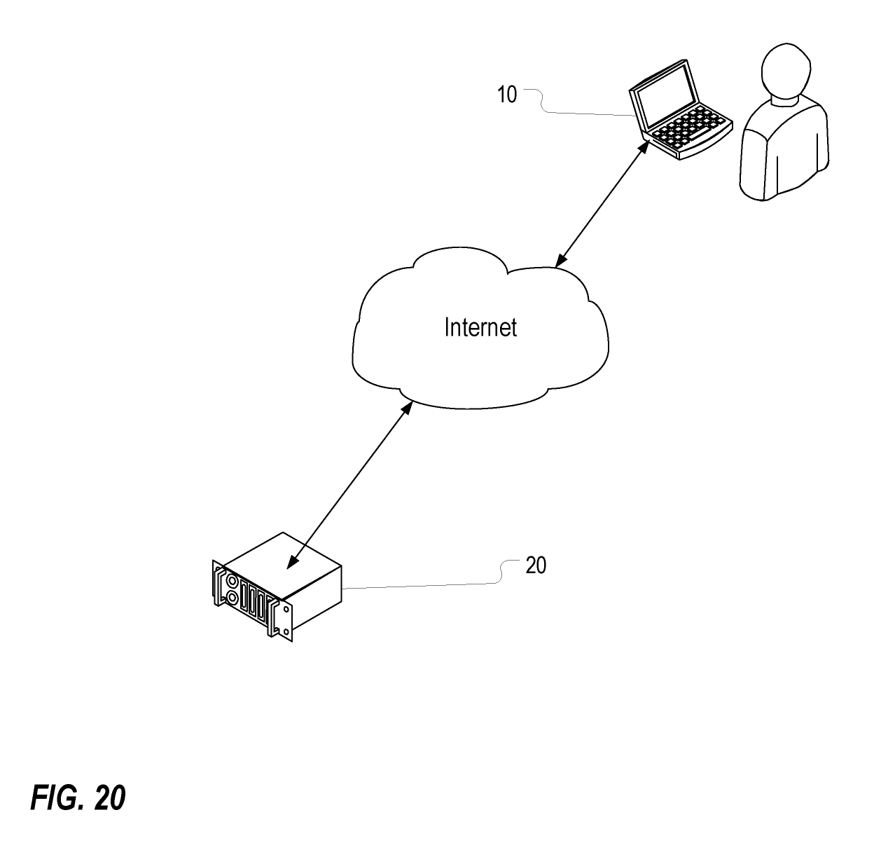

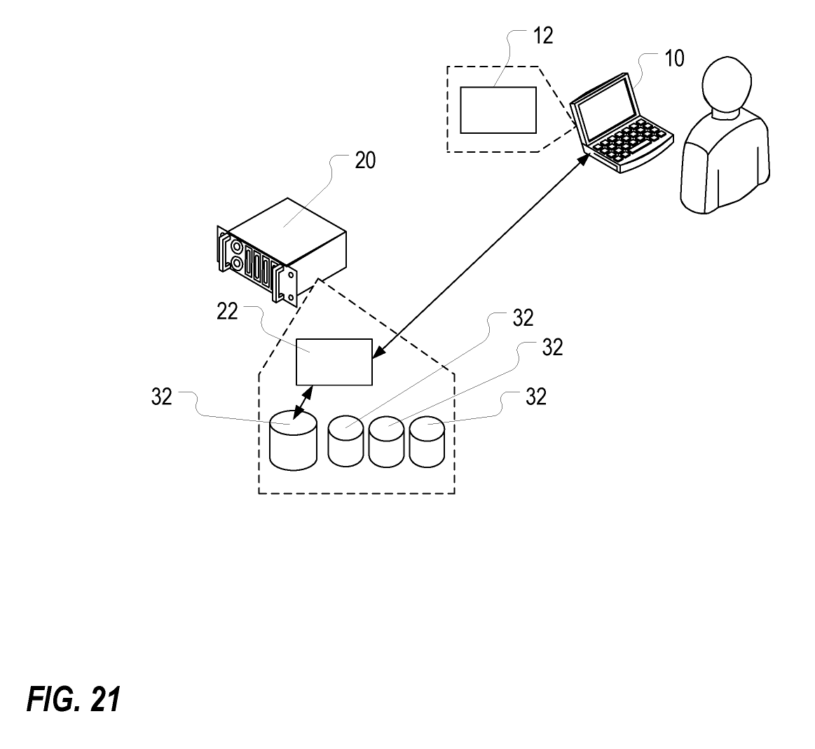

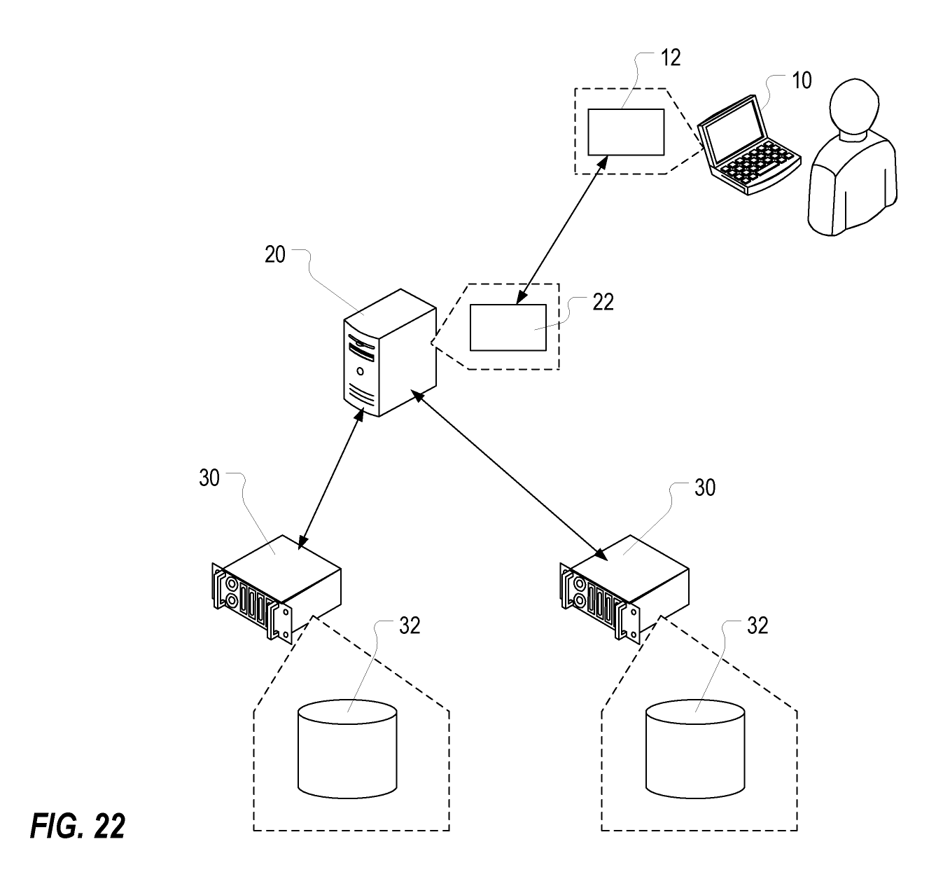

Various implementations utilizing an interface of a system are disclosed herein. It will be appreciated that disclosed interfaces may be part of an application, or even a spreadsheet, or may be part of a web interface accessible over a network connection, e.g. over the Internet. A system may comprise one or more servers or cloud servers. FIG. 20 illustrates an example architecture for an exemplary implementation in which a user accesses a web portal of a platform via a laptop 10 or other computing device. The web portal comprises a web service 22 hosted at one or more web servers 20, as illustrated in FIG. 21. A web browser application 12 running at a user device 10 may access the web portal by accessing a particular URL or URI which effects communication with the web service 22, as illustrated in FIG. 21. The web portal may be configured to provide access to data from one or more databases 32, e.g. SQL databases. These databases may be local to a web server on which the web service 22 is running as illustrated in FIG. 21, or may be remote on another machine such as a database server 30, as illustrated in FIG. 22. In accordance with one or more preferred implementations, one or more web servers and/or database servers may be virtual machines.

In accordance with one or more preferred implementations, a system may even be implemented utilizing a spreadsheet, e.g. in Microsoft Excel or Filemaker. In accordance with one or more preferred implementations, a care coordinator spreadsheet provides a visual representation of patients who have been discharged from a hospital on a Y-axis and a listing of ancillary teams on an X-axis (such as Pharmacy, Community Education, Home Health, etc.) available to provide services to a patient. In accordance with one or more preferred implementations, the spreadsheet is a shared file between multiple users (e.g. there might be thirteen teams who will be accessing it daily with multiple members within each team). In accordance with one or more preferred implementations, the file lives inside of a shared folder, which users can place on their desktop, and access to the shared folder is controlled by permissions in an IT department. In this way, only certain hospital departments and their members will be allowed access, but once inside, can visually track what all other users are doing.

In accordance with one or more preferred implementations, an interface, whether of a spreadsheet or a web interface, has multiple columns including patient information such as a condition. In accordance with one or more preferred implementations, upon certain events, other events are triggered, such as when a call is made by nursing it documents whether the call went through and automatically generates a new task. As an example, if a call is made and a patient has been put into hospice, then a notice might be provided for a pastor/spiritual advisor to follow up. If the call does not go through, a missed call is documented and a follow up call is scheduled.

In accordance with one or more preferred implementations, many tasks are done through dropdown menus (e.g. in Excel). For example, if a nurse discovers that a patient is deceased, the nurse can utilize a dropdown to indicate the patient is deceased, and this could trigger other calls or notices depending on programming. In accordance with one or more preferred implementations, a system might require repeat follow up calls for high risk patients.

In accordance with one or more preferred implementations, tracking methodologies and systems help to prevent readmissions.

In accordance with one or more preferred implementations, a methodology utilizes personal calls rather than automated calls, while in one or more preferred implementations a methodology alternatively or additionally utilizes automated calls or automated dialers, with voice call upon pickup.

In accordance with one or more preferred implementations, an interface includes a plurality of columns for storing data associated with patients.

In accordance with one or more preferred implementations, these columns include a column for storing a patient's name. In accordance with one or more preferred implementations, data in this column is color coded to quickly convey information about a patient. In accordance with one or more preferred implementations, a cell in this column might be color coded a rust color to indicate one prior readmission within the last ninety days, a yellow color to indicate two prior readmissions within the last ninety days, or red to indicate more than two prior readmissions within the last ninety days.

In accordance with one or more preferred implementations, these columns further include a medical record number column, an account number column, and a date of birth column.

In accordance with one or more preferred implementations, these columns include a consent column, which specifies whether a patient has consented to be contacted. In accordance with one or more preferred implementations, data in this column is color coded. For example, red may indicate that a patient has specified that they do not want to be contacted, while orange may indicate that a patient has specified that calls are okay, but do not leave a message.

In accordance with one or more preferred implementations, these columns include a consent comment column, which might provide a comment regarding consent that a patient provided, e.g. “do not contact me before 10 AM” or “only leave messages with my spouse”.

In accordance with one or more preferred implementations, these columns include a preferred contact phone number column. In accordance with one or more preferred implementations, data in this column is color coded based on information in the consent column, e.g. red may indicate that a patient has specified that they do not want to be contacted, while orange may indicate that a patient has specified that calls are okay, but do not leave a message.

In accordance with one or more preferred implementations, these columns include: a contact person column, an attending physician column, a consulting specialist column, a primary care provider column (may be color coded red if the patient does not have a primary care physician), one or more insurance columns, a code status column (e.g. Do Not Resuscitate, Do Not Intubate, etc.), one or more diagnoses columns (may be color coded pink to indicate a calculated risk of sepsis), a complete discharge medication list column, a procedures column (may be highlighted pink if keywords indicate surgical procedures), a gender column, a date of discharge column, and an allergies column.

In accordance with one or more preferred implementations, these columns include a patient age column, which is preferably calculated from date of birth information. Data in this column may be color coded to indicate high risk of readmission due to being very young or very old. For example, patients that are very young may be highlighted in light blue, those that are less than three months may be highlighted in red letters on blue, and those that are very old may be highlighted in red.

In accordance with one or more preferred implementations, these columns include a column indicating a number of readmissions for a patient within the last ninety days. In accordance with one or more preferred implementations, if a patient has been readmitted twice, yellow color coding will be utilized, while if a patient has been readmitted more than twice, then red color coding will be utilized.

In accordance with one or more preferred implementations, these columns include a prior discharge date column, which indicates a prior discharge date if a patient has been readmitted after having been previously admitted within the last ninety days.

In accordance with one or more preferred implementations, these columns include a patient status column, which might specify that a patient's status is inpatient, outpatient, observation, emergency department, outpatient in a bed, etc.

In accordance with one or more preferred implementations, these columns include: an arrival date column, a length of stay column, a discharge time column (preferably highlighted in progressively warm colors to indicate that risk of readmission rises with later discharges), a primary language of patient column, a time preference column (indicating a time of day a patient prefers to be contacted), a learning deficit column (indicating whether a patient has a learning deficit), a sensory deficit column (indicating for example whether a patient has an auditory or visual deficit), a unit column, a discharge nurse column listing the discharge nurse, a living situation column providing a narrative of a patient's living situation, and a pysch or cognitive column detailing psychiatric diagnoses or history or cognitive/behavioral difficulty.

In accordance with one or more preferred implementations, one or more columns may be populated with data based on analysis of data imported or input into the system. For example, in one or more preferred implementations, keyword analysis may be performed on a discharge entry imported from an admission/discharge/transfer system and utilized to determine whether a discharge is into a likely poor living situation.

In accordance with one or more preferred implementations, these columns may include one or more columns including information associated with calculation of a risk of developing an infection or sepsis.

In accordance with one or more preferred implementations, these columns may include columns including information associated with calculation of a risk of readmission score. In accordance with one or more preferred implementations, an enhanced risk of readmission score maybe calculated and included in a column which is based at least partially on advanced age, infection risk, and chemical dependency.

In accordance with one or more preferred implementations, a risk of readmission score is calculated based at least in part on data from other columns such, as for example, a risk of infection/sepsis column, a history of non-compliance column indicating past non-compliance with a treatment plan, a repeat emergency department column indicating frequent use of emergency services, a needs assistance column indicating a need for special physical assistance, a history of falls column indicating two or more falls in the last twelve months or any fall with injury, a likely poor living situation column, a column indicating whether discharge occurred after 5 PM (risk of readmission is generally increased for discharges after 5 PM), and a column indicating whether discharge occurred on a weekend (errors and oversights in the discharge process are generally more likely on Friday, Saturday, and Sunday discharges).

In accordance with one or more preferred implementations, a cell may be color coded purple to indicate that data is not available for that cell, and that data should be obtained and input if possible.

In accordance with one or more preferred implementations, an interface of a dashboard preferably includes a header which presents summary information for data displayed in the interface. For example, this header may display information regarding a percentage of readmitted patients per a total number of discharged patients within the dashboard, as well as a total number of readmissions for a facility within the last ninety days.

In accordance with one or more preferred implementations, an interface includes a plurality of columns associated with coordination of teams.

In accordance with one or more preferred implementations, these columns include a column indicating the date a patient was last contacted by any team or service. In accordance with one or more preferred implementations, data in this column is color coded blue if a patient has already been contacted today.

In accordance with one or more preferred implementations, these columns include a column indicating a date that a patient was first contacted by a team, e.g. nursing. In accordance with one or more preferred implementations, data in this column is color coded green to indicate that a patient was contacted within two days of discharge, yellow to indicate that a patient was contacted on the third day, or red to indicate that a patient was contacted four or more days after discharge.

In accordance with one or more preferred implementations, these columns include a column indicating that a nursing call is required. In accordance with one or more preferred implementations, in a header, calls that are required are counted by department, e.g. ICU, Telemetry, MedSurg, etc.

In accordance with one or more preferred implementations, these columns include a column indicating when a next call from a team, e.g. nursing, is due. In accordance with one or more preferred implementations, this column sets an automatic reminder for team members to recall the patient on that date. In accordance with one or more preferred implementations, this occurs by the system automatically updating an appropriate column on that date (e.g. a nursing call column) to indicate that a call is needed. In accordance with one or more preferred implementations, a column indicating when a next call is due may be color coded purple to indicate that a date needs to be entered. For example, if a patient is high risk, a system may automatically change the nursing call column to indicate a call is required, and also highlight a column indicating when a next call is due purple to indicate that the patient is high risk and another call needs to be scheduled.

In accordance with one or more preferred implementations, one or more columns may be related to a maternal child health team. In accordance with one or more preferred implementations, if a patient is discharged from a neo-natal intensive care unit, a obstetric department, or a pediatric department, a request for communication from the maternal child health team may automatically be triggered. In accordance with one or more preferred implementations, if a patient or parent or guardian cannot be reached after three attempts, a request for a communication from a manager may be triggered.

In accordance with one or more preferred implementations, one or more columns may be related to a primary care physician or specialist. In accordance with one or more preferred implementations, data in a column associated with a need for a primary care physician or specialist follow up may be color coded purple to indicate that a primary care physician or specialist needs to be assigned, lavender to indicate that a primary care physician or specialist has been identified but no appointment has been made, or white to indicate that an appointment has been made and confirmed. In accordance with one or more preferred implementations, data in a column associated with an appointment with a primary care physician or specialist may be color coded red to indicate that no primary care physician or specialist has been identified, yellow to indicate that a primary care physician or specialist is known but no appointment has been made, or green to indicate that an appointment has been made.

In accordance with one or more preferred implementations, one or more columns may be related to a pharmacy team. In accordance with one or more preferred implementations, one or more columns may indicate requests for patient contact, as well as suggestions for patient contact. In accordance with one or more preferred implementations, suggestions for patient contact are triggered based on known risk factors. In accordance with one or more preferred implementations, requests for patient contact are counted in a task count proximate a top of a column, while suggestions for patient contact are not. In accordance with one or more preferred implementations, known risk factors may include, for example, an indication that a patient has been tagged as a “polypharm”, e.g. has seven or greater listed medications.

In accordance with one or more preferred implementations, one or more columns may be related to coordinating communications for the following teams: a cardiac and pulmonary rehab team, a home health team, a care transitions team, a virtual therapy team, a care coordination team, a social work and psych team, a spiritual care team, a palliative/hospice team.

In accordance with one or more preferred implementations, one or more columns may be utilized to track referrals to management, e.g. a manager or supervisor.

In accordance with one or more preferred implementations, one or more columns may be utilized to track a need to send a letter, e.g. because a patient could not be reached after three attempts.

Systems disclosed herein provide an interface which can be utilized as a task list for teams to keep track of communications that need to be performed. Due to time limitations, however, and based upon various risk levels, some patients need to be prioritized to be called first. For example, a ninety year old patient with an open wound is much more at risk than a teenage patient recovering from knee surgery to fix a torn ACL.

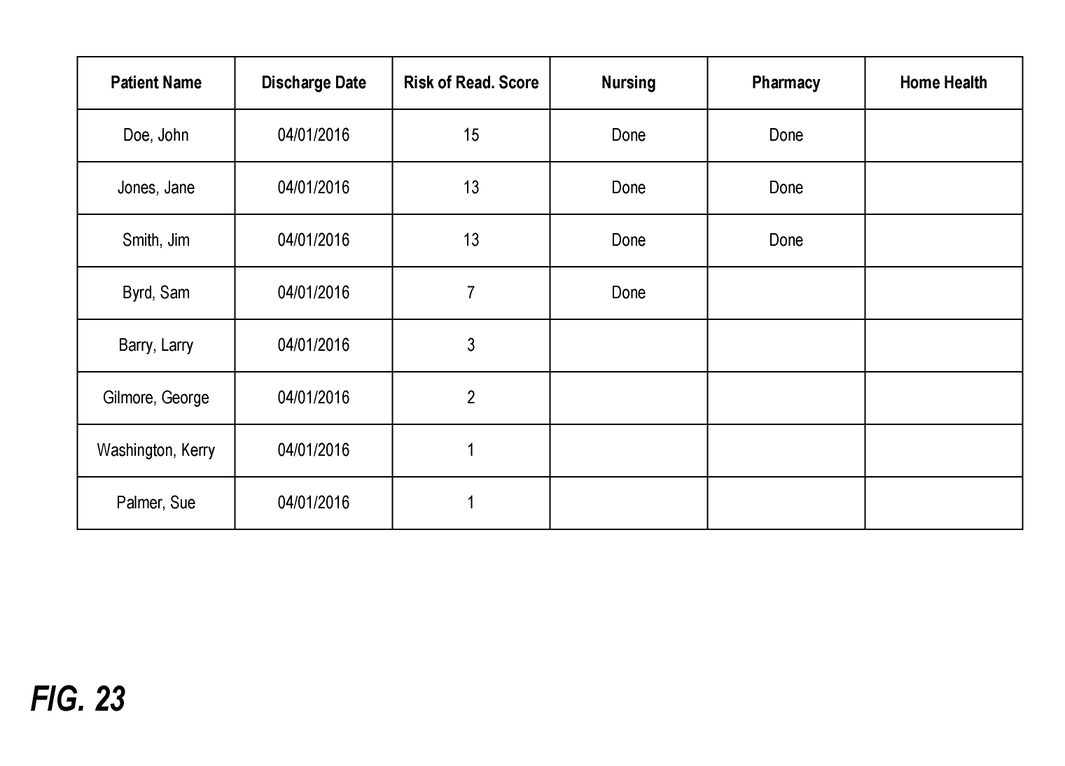

In accordance with one or more preferred implementations, patients are sorted in an interface based on a risk of readmission score. FIG. 23 illustrates an exemplary interface sorting patients in this manner.

In accordance with one or more preferred implementations, patients may be sorted based on a modified risk of readmission score or based on another score which may be generated based at least in part on various risk factors identified in available data from the system.

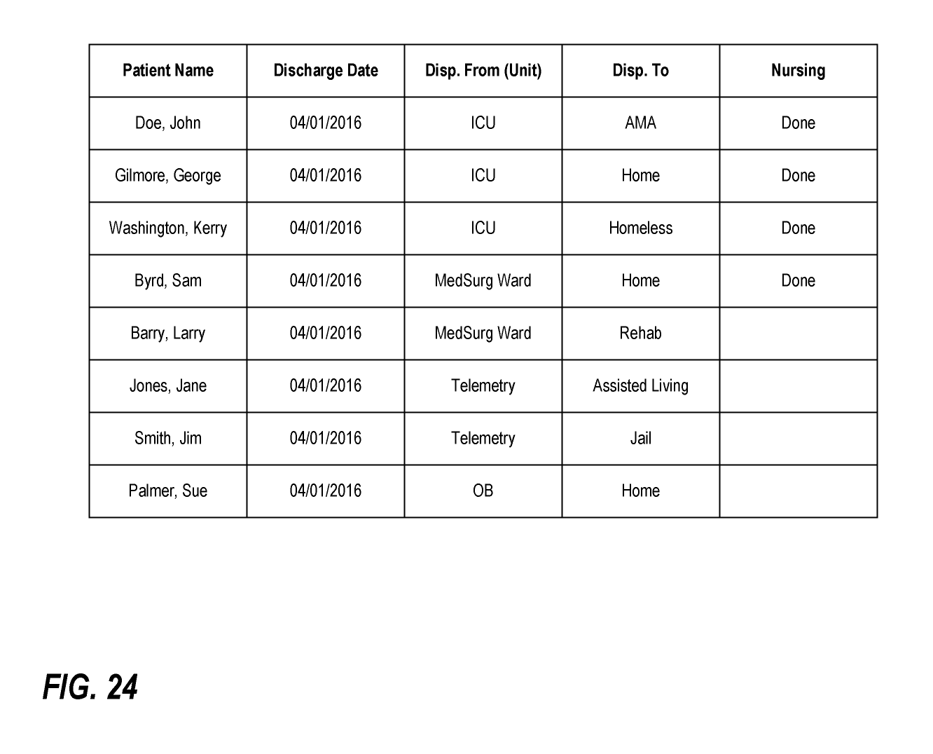

In accordance with one or more preferred implementations, patients are sorted based on multiple data points. In accordance with one or more preferred implementations, patients are associated with a disposition from a particular unit, and are first sorted by a discharge date, and then by the unit from which they were disposed from, as illustrated in FIG. 24. In accordance with one or more preferred implementations, patients are then sorted by a primary language, so that specific language speakers from each department can work on those patients for whom they are able to communicate with. In accordance with one or more preferred implementations, patients are then sorted by a time of day preference that a patient prefers to be called, with those preferring to be called earlier in the day being sorted ahead of those preferring to be called later. In accordance with one or more preferred implementations, patients are then sorted based on risk factors, e.g. based on a calculated risk of readmission score.

Although disclosed herein largely in the context of a system configured for use in coordinating communications or tasks related to discharged patients, in accordance with one or more preferred implementations systems are configured for use in coordinating communications or tasks in other contexts.

By way of non-limiting example, in accordance with one or more preferred implementations, a system is configured for coordinating communications and tasks in a real estate context. In accordance with one or more preferred implementations, rows of an interface are configured to correspond to properties and/or deals, and one or more columns of an interface are associated with different teams, users, or individuals.

Based on the foregoing description, it will be readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention. Accordingly, while the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements, the present invention being limited only by the claims appended hereto and the equivalents thereof

1. A method for facilitating coordination between teams concerned with care of patients, the method comprising:
(a) importing, into a system, data for a plurality of patients from one or more medical software programs;
(b) displaying, to a first user via a display of a first electronic device, an interface comprising a plurality of rows and a plurality of columns, the interface comprising data imported into the system, and the rows including a plurality of rows each corresponding to a particular patient, wherein
(i) the columns include a plurality of columns each corresponding to a particular one of the teams concerned with care of patients, and for each respective cell lying in a respective row associated with a respective patient and in a respective column associated with a respective team, the interface is configured to allow for both
(A) display in the respective cell of a status message indicating a status of communication by the respective team with the respective patient, and
(B) user interaction with the respective cell which
(I) effects display of a menu of available actions that can be requested of the respective team with respect to the respective patient, and
(II) effects selection of one of the available actions,
(C) wherein user selection of an available action effects updating in the interface of a displayed status message for the respective cell, and
(ii) the columns include a column containing a calculated risk score,
(iii) rows associated with a patient are sorted based at least in part on respective calculated risk scores for each patient to prioritize communications with patients who are at greater risk;
(c) receiving, from the first user via one or more input devices associated with the first electronic device, input corresponding to interaction with a first respective cell associated with a first respective patient and a first respective team, such input representing a request to effect communication with the first respective patient by the first respective team;
(d) updating, based on the received user input representing a request to effect communication with the first respective patient by the first respective team, the first respective cell of the interface to indicate the request;
(e) displaying, to a second user via a display of a second electronic device, the updated interface including the indication of the request in the first respective cell;
(f) receiving, from the second user via one or more input devices associated with the second electronic device, input corresponding to interaction with the first respective cell, such input representing an indication of a status of communications with the first respective patient by the first respective team;
(g) updating, based on the received user input representing an indication of a status of communications with the first respective patient by the first respective team, the first respective cell to reflect such status; and
(h) displaying, to the first user via the display of the first electronic device, the updated interface including the indicated status of communications in the first respective cell.

2. The method of claim 1, wherein the system comprises a spreadsheet, and wherein importing into the system comprises importing into a spreadsheet.

3. The method of claim 1, wherein the system comprises a web application configured to generate an interface utilizing data from an SQL database, and wherein importing into the system comprises importing into an SQL database.

4. The method of claim 1, wherein the patients are patients discharged from a medical facility.

5. The method of claim 1, wherein the interface comprises a row which displays, for each respective column associated with a respective team, a count of action items or requests for communication which need to be attended to by the particular team, these counts being automatically updated by the system in response to user input.

6. The method of claim 1, wherein the first electronic device comprises a touchscreen device, and the first user provides input via a touchscreen of the first electronic device.

7. The method of claim 1, wherein the first electronic device comprises a computer, and the first user provides input via a mouse and keyboard associated with the first electronic device.

8-9. (canceled)

10. The method of claim 1, wherein the teams represent departments of a hospital.

11-15. (canceled)

16. The method of claim 1, wherein rows associated with patients are sorted based at least in part on a respective discharge date for each patient.

17. The method of claim 1, wherein rows associated with patients are sorted based at least in part on a respective unit each patient was disposed from to group patients disposed from the same unit together.

18. The method of claim 1, wherein rows associated with patients are sorted based at least in part on a primary language each patient speaks to group patients who speak the same language together.

19. The method of claim 1, wherein rows associated with patients are sorted based at least in part on a time of day each patient prefers to be contacted.

20. The method of claim 1, wherein rows associated with patients are sorted first based on a respective discharge date, then based on a respective disposed from unit, then based on a respective primary language, then based on a respective preferred contact time of day, then based on a calculated risk score.

21. The method of claim 1, wherein cells in the interface are color coded to quickly convey information.

22. The method of claim 1, wherein data in cells in the interface is color coded to quickly convey information.

23. The method of claim 1, wherein the interface is configured to effect display of a menu of available actions by effecting display of a dropdown menu.

24. A method for facilitating coordination between teams concerned with entities, the method comprising:
(a) importing, into a system, data for a plurality of entities;
(b) displaying, to a first user via a display of a first electronic device, an interface comprising a plurality of rows and a plurality of columns, the interface comprising data imported into the system, and the rows including a plurality of rows each corresponding to a particular entity, wherein
(i) the columns include a plurality of columns each corresponding to a particular one of the teams concerned with the entities, and for each respective cell lying in a respective row associated with a respective entity and in a respective column associated with a respective team, the interface is configured to allow for both
(A) display in the respective cell of a status message indicating a status of actions by the respective team with respect to the respective entity, and
(B) user interaction with the respective cell which
(I) effects display of a menu of available actions that can be requested of the respective team with respect to the respective entity, and
(II) effects selection of one of the available actions,
(C) wherein user selection of an available action effects updating in the interface of a displayed status message for the respective cell, and
(ii) the columns include a column containing a calculated risk score,
(iii) rows associated with an entity are sorted based at least in part on respective calculated risk scores for each entity to prioritize communications with entities having a greater risk;
(c) receiving, from the first user via one or more input devices associated with the first electronic device, input corresponding to interaction with a first respective cell associated with a first respective entity and a first respective team, such input representing a request to undertake an action with respect to the first respective entity by the first respective team;
(d) updating, based on the received user input representing a request, the first respective cell of the interface to indicate the request;
(e) displaying, to a second user via a display of a second electronic device, the updated interface including the indication of the request in the first respective cell;
(f) receiving, from the second user via one or more input devices associated with the second electronic device, input corresponding to interaction with the first respective cell, such input representing an indication of a status of action with respect to the first respective entity by the first respective team;
(g) updating, based on the received user input representing an indication of a status of action with respect to the first respective entity by the first respective team, the first respective cell to reflect such status; and
(h) displaying, to the first user via the display of the first electronic device, the updated interface including the indicated status of action in the first respective cell.

25. The method of claim 24, wherein a team may represent a single person.

26. The method of claim 24, wherein a team comprises one or more people.

27-29. (canceled)

30. A method for facilitating coordination between teams concerned with entities, the method comprising:
(a) importing, into a system, data for a plurality of entities;
(b) displaying, to a first user via a display of a first electronic device, an interface comprising a plurality of rows and a plurality of columns, the interface comprising data imported into the system, and the rows including a plurality of rows each corresponding to a particular entity, wherein
(i) the columns include a plurality of columns each corresponding to a particular one of the teams concerned with the entities, and for each respective cell lying in a respective row associated with a respective entity and in a respective column associated with a respective team, the interface is configured to allow for both
(A) display in the respective cell of a status message indicating a status of actions by the respective team with respect to the respective entity, and
(B) user interaction with the respective cell which
(I) effects display of a menu of available actions that can be requested of the respective team with respect to the respective entity, and
(II) effects selection of one of the available actions,
(C) wherein user selection of an available action effects updating in the interface of a displayed status message for the respective cell;
(c) receiving, from the first user via one or more input devices associated with the first electronic device, input corresponding to interaction with a first respective cell associated with a first respective entity and a first respective team, such input representing a request to undertake an action with respect to the first respective entity by the first respective team;
(d) updating, based on the received user input representing a request, the first respective cell of the interface to indicate the request;
(e) displaying, to a second user via a display of a second electronic device, the updated interface including the indication of the request in the first respective cell;
(f) receiving, from the second user via one or more input devices associated with the second electronic device, input corresponding to interaction with the first respective cell, such input representing an indication of a status of action with respect to the first respective entity by the first respective team;
(g) updating, based on the received user input representing an indication of a status of action with respect to the first respective entity by the first respective team, the first respective cell to reflect such status; and
(h) displaying, to the first user via the display of the first electronic device, the updated interface including the indicated status of action in the first respective cell.

31-37. (canceled)
